(19) United States
(12) Patent Application Publication
(10) Pub. No.: US 2025/0315140 A1
(43) Pub. Date: Oct. 9, 2025

(54) SYSTEMS, METHODS, AND DEVICES FOR SMART FEEDBACK

(71) Applicant: Anram Holdings, Oakville (CA)

(72) Inventors: Kautilya PANDYA, Scarborough (CA); Ajay VISHNU, Haryana (IN); Jose Miguel BARRIOS SIERRA, Burlington (CA); Subhadeep BISWAS, West Bengal (IN); Romil Hitenbhai DALVADI, Brampton (CA)

(73) Assignee: Anram Holdings, Oakville (CA)

(21) Appl. No.: 18/955,353

(22) Filed: Nov. 21, 2024

(30) Foreign Application Priority Data
Apr. 8, 2024 (IN) 202411028665
Aug. 30, 2024 (WO) PCT/IB2024/058448

(51) Int. Cl. G06F 3/0481; G06F 3/02; G06F 3/0484; G06F 3/14; G06K 19/06

(52) U.S. Cl. CPC G06F 3/0481; G06F 3/02; G06F 3/0484; G06F 3/14; G06K 19/06037

(57) ABSTRACT

Embodiments of the present application disclose systems, methods, and devices for smart feedback. One embodiment includes a system including a portable apparatus and a display device operating in communication therewith. The portable apparatus includes one or more physical press buttons. The portable apparatus is configured to perform a function in response to the one or more physical press buttons being manipulated. The display device is configured to display a machine-readable code including a reference to a webpage featuring a digital replica of the portable apparatus.

### TECHNICAL FIELD

The present application generally relates to data collection and feedback systems and particularly relates to systems, methods, and devices for smart feedback collection and response management.

### BACKGROUND

A well-cleaned and tidy facility is universally appreciated. Within a commercial context, a clean and orderly facility contributes to the well-being, morale, and productivity of its occupants. Moreover, it plays a pivotal role in elevating customer satisfaction and creating a lasting positive impression on potential clients and visitors, thereby enhancing both sales and the overall brand image of the underlying business. Often, cleaning or janitorial staff performs various cleaning tasks, such as garbage disposal, removal of dust and stains from surfaces, and restocking required supplies to maintain the facility in order. These tasks are typically executed on a set schedule; however, a rigid timetable to perform the cleaning tasks can lead to inconsistent hygiene, inadequate response to peak usage periods, elevated risk of contamination spread, and suboptimal user experience. Consequently, a responsive cleaning process is generally implemented with, or without, the scheduled cleaning for comprehensive facility maintenance. However, the existing responsive cleaning process depends on expensive monitoring hardware (e.g., cameras, radiofrequency (RF) beacons, time-of-flight (TOF) sensors, etc.) and related software that adds to the operational complexity, longer set-up times, and higher costs for system development, operation, maintenance, and user training.

In a conventional approach to facilitate responsive cleaning, customers typically use a smartphone (first device) to provide feedback on a state of cleanliness and that of equipment (such as soap dispensers, garbage bins, toilet roll holders, etc.) within an indoor facility, such as a room or a restroom. Typically, the smartphone hosts a software application (App), or provides access to a web portal hosted on a server (additional device), allowing facility users to input their feedback. The App or web portal then sends a notification based on the received feedback. This notification is directed to a mobile device (second device) used by a janitor. Upon receiving the notification, the janitor carries the mobile device (such as a smartcard, beacon, or mobile phone) into the indoor facility for performing various cleaning tasks therein. The mobile device is generally pre-linked to a sensor device (third device) that is pre-installed within the indoor facility. Typically, the sensor device continuously scans for the pre-linked mobile device and registers the presence of the janitor inside the indoor facility when the pre-linked mobile device is detected. The janitor usually registers their presence by having the pre-linked mobile device scanned by the sensor device and then proceeds to perform the cleaning tasks within the indoor facility.

The traditional approach described above necessitates the use of a system of multiple devices for collecting customer feedback and detecting the janitor's availability in the indoor facility. This multi-device system complicates the system implementation and often requires the extensive training of facility users about its usage. Furthermore, facility users, such as customers, are often discouraged or unmotivated to provide feedback due to various extra steps of accessing the App or the web portal after using indoor facilities like restrooms. Typically, such App (or web portal) features a complicated, long-form interface filled with dense textual information and lacking any incentives for users to provide feedback. The complexity of conventional feedback forms on the App or web portal also overwhelms and confuses users, leading to frustration, lower response rates, and incomplete or inaccurate feedback submissions.

Moreover, the multi-device system typically relies on sophisticated software to continuously collect and transmit feedback and device detection data. This reliance on complex software and continuous data transfer over the network makes the system costly, computationally demanding, and rapidly drains battery in the underlying devices. Additionally, the sensor device often incorporates proximity sensors (or motion sensors) to detect the pre-linked mobile device. These sensors heighten power consumption by the sensor device, leading to increased battery usage, wear and tear, as well as higher operational and maintenance costs. Furthermore, the sensor device usually records only a login clock time when the mobile device is detected, indicating the janitor's immediate presence in the indoor facility. However, such conventional sensor device fails to accurately determine when the janitor has completed cleaning tasks, especially if the pre-linked mobile device is left unattended within the scan range of the sensor device. This may complicate the tracking of janitors and the monitoring of cleaning task progress/completion. Additionally, janitors may misplace or forget to carry their pre-linked mobile devices (e.g., smartcard, mobile phone, etc.) into the indoor facility, resulting in unreliable tracking of cleaning tasks and the janitor's presence inside the indoor facility.

In an alternative approach to responsive cleaning, various facility equipment (such as soap dispensers, garbage bins, toilet roll holders, urinal sprinklers, and hutches for consumables) may be equipped with individual tracking sensors for real-time status monitoring. These tracking sensors typically detect changes in the equipment's state, such as an empty soap dispenser, a full bin, or depleted toilet roll, and transmit this data either to a linked sensor device or to the mobile device carried by the janitor. The tracking sensors eliminate the need for feedback from facility users. However, the addition of individual tracking sensors to each piece of facility equipment increases the setup time as well as the operational and maintenance costs of the entire system.

Other common approaches depend on additional hardware, including cameras and active radiofrequency (RF) beacons, installed inside the indoor facility to monitor the availability or presence of janitors and their cleaning tasks. However, these hardware-intensive solutions are often cost-prohibitive, require longer setup times, and suffer from higher computational overhead and increased memory usage, leading to rapid battery depletion and increased wear and tear of the underlying components and devices.

### SUMMARY

One embodiment of the present application includes a system including a portable apparatus and a display device operating in communication therewith. The portable apparatus may include one or more physical press buttons. The portable apparatus may be configured to perform a function in response to the one or more physical press buttons being manipulated. The display device may be configured to display a machine-readable code including a reference to a webpage featuring a digital replica of the portable apparatus.

Another embodiment of the present application includes a system including a user interface and a controller operating in communication therewith. The user interface displays a digital replica of a remote apparatus. The digital replica includes one or more digital buttons, where the digital replica is associated with a unique identifier of the remote apparatus configured to perform a function. The controller may be configured to perform the function independent of the remote apparatus, where the function may be performed in response to the one or more digital buttons being manipulated. The controller may provide an output based on the function being performed. The controller may be further configured to associate the output with the unique identifier of the remote apparatus.

The above summary of exemplary embodiments is not intended to describe each disclosed embodiment or every implementation of the present disclosure. Other and further aspects and features of the disclosure would be evident from reading the following detailed description of the embodiments, which are intended to illustrate, not limit, the present disclosure.

### BRIEF DESCRIPTION OF DRAWINGS

The illustrated embodiments of the subject matter will be best understood by reference to the drawings, wherein like parts are designated by like numerals throughout. The following description is intended only by way of example, and simply illustrates certain selected embodiments of devices, systems, and processes that are consistent with the subject matter as described herein.

FIG. 1 illustrates an exemplary portable apparatus for responsive feedback management, according to an embodiment of the present application.

FIG. 2 illustrates an exemplary network environment implementing the portable apparatus of FIG. 1, according to an embodiment of the present application.

FIGS. 3-5 illustrates different views of the portable apparatus of FIG. 1 configured as an exemplary handheld terminal, according to an embodiment of the present application.

FIG. 6 illustrates the portable apparatus of FIG. 1 configured as an exemplary mobile terminal, according to an embodiment of the present application.

FIG. 7 illustrates the handheld terminal of FIG. 3 displaying an exemplary dynamic, secure machine-readable code, according to an embodiment of the present application.

FIG. 8 illustrates an exemplary scenario for accessing data associated with the machine-readable code of FIG. 7, according to an embodiment of the present application.

FIG. 9 illustrates an exemplary method of generating the machine-readable code of FIG. 7, according to an embodiment of the present application.

FIG. 10 illustrates an exemplary interactive digital replica of the handheld terminal of FIG. 7 accessed in a portrait orientation on a remote device in communication with a server, according to an embodiment of the present application.

FIG. 11 illustrates the digital replica of FIG. 10 accessed in a landscape orientation on a remote device, according to an embodiment of the present application.

FIG. 12 illustrates exemplary indications displayed on a virtual display unit associated with the digital replica of FIG. 10, according to an embodiment of the present application.

FIG. 13 is a signal diagram illustrating an exemplary method of implementing a feedback mode on the handheld terminal of FIG. 7, according to an embodiment of the present application.

FIG. 14 is a signal diagram illustrating an exemplary method of implementing a data update mode on the handheld terminal of FIG. 7, according to an embodiment of the present application.

FIG. 15 is a signal diagram illustrating an exemplary method of implementing a data upload mode on the handheld terminal of FIG. 7, according to an embodiment of the present application.

FIG. 16 is a signal diagram illustrating an exemplary method of implementing a maintenance mode on the handheld terminal of FIG. 7, according to an embodiment of the present application.

FIG. 17 is a signal diagram illustrating an exemplary method of implementing a Wi-Fi™ check mode on the handheld terminal of FIG. 7, according to an embodiment of the present application.

FIG. 18 is a signal diagram illustrating an exemplary method of implementing a validation mode on the handheld terminal of FIG. 7, according to an embodiment of the present application.

FIG. 19 is a signal diagram illustrating an exemplary method of implementing a cleaning mode on the handheld terminal of FIG. 7, according to an embodiment of the present application.

FIG. 20 illustrates exemplary indications displayed on a display unit associated with the handheld terminal of FIG. 7, according to an embodiment of the present application.

FIG. 21 illustrates an exemplary network environment implementing the handheld terminal of FIG. 7, according to an embodiment of the present application.

### DETAILED DESCRIPTION

The following detailed description is provided with reference to the drawings herein. Exemplary embodiments are provided as illustrative examples so as to enable those skilled in the art to practice the application. It will be appreciated that further variations of the concepts and embodiments disclosed herein can be contemplated. The examples described in the present application may be used together in different combinations. In the following description, details are set forth in order to provide an understanding of the present application. It will be readily apparent, however, that the present application may be practiced without limitation to all these details. Also, throughout the present application, the terms “a” and “an” are intended to denote at least one of a particular element. The terms “a” and “an” may also denote more than one of a particular element. As used herein, the term “includes” means includes but not limited to, the term “including” means including but not limited to. The term “based on” means based at least in part on, the term “based upon” means based at least in part upon, and the term “such as” means such as but not limited to. The term “relevant” means closely connected or appropriate to what is being done or considered. The term “approximately” means a variation of +/−5% in a stated number or a value of a stated parameter.

Further, where certain elements of the present application can be partially or fully implemented using known components, only those portions of such known components that are necessary for an understanding of the present application will be described, and detailed descriptions of other portions of such known components are omitted so as not to obscure the invention(s). In the present application, an embodiment showing a singular component should not be considered limiting; rather, the present application is intended to encompass other embodiments including a plurality of the same component, and vice-versa, unless explicitly stated otherwise herein. Moreover, the applicant does not intend for any term in the present application to be ascribed an uncommon or special meaning unless explicitly set forth as such. The present application also encompasses present and future known equivalents to the components referred to herein.

### Non-Limiting Definitions

Definitions of one or more terms that will be used in this disclosure are described below without limitations. For a person skilled in the art, it is understood that the definitions are provided only for the sake of clarity and are intended to include more examples than just provided below.

A term “software product” is used in the present application in the context of its broadest definition. The software product may refer to a computer code implemented on a computer readable medium and operable to control or influence an intended function of hardware or an effect related thereto.

A term “software patch” is used in the present application in the context of its broadest definition. The “software patch” may refer to a computer code designed to operate in combination with the software product. In some examples, the software patch may correspond to an incomplete version of the software product. Other examples may include the software patch configured to complement, enhance, or inhibit a function or effect of the software product.

A term “user” is used in the present application within the context of its broadest definition. The user may refer to a person, a machine, an artificial intelligence (AI) unit, or any other entity. The entity may also include a group of persons or organizations, including but not limited to professional services firms, product manufacturers, finance management organizations, real estate companies, marketing agencies, marketplaces, and similar entities.

A term “clock” is used in the present application in the context of its broadest definition. The “clock” may refer to a device, element, component, unit, or module being configured to continuously, or at discrete intervals, determine and provide the present time.

### Exemplary Embodiments

Embodiments are disclosed in the context of a portable apparatus for responsive feedback management; however, one having ordinary skill in the art would understand that the concepts described in the present application may be implemented to various applications including, but are not limited to, point-of-sales (POS) systems, self-service kiosks, information management and reporting, customer feedback and survey terminals, voting or polling stations, bill payment, event ticketing and booking management, vehicle parking management, custodial and cleaning services, inventory and asset management, data and energy usage management, visitor management, employee access control, remote asset tracking, vending machines, health screening stations, branding and advertising. Some embodiments may assist in (i) remote management of a local activity, (ii) time or priority management, and (iii) targeted branding and advertising of companies or offerings therefrom.

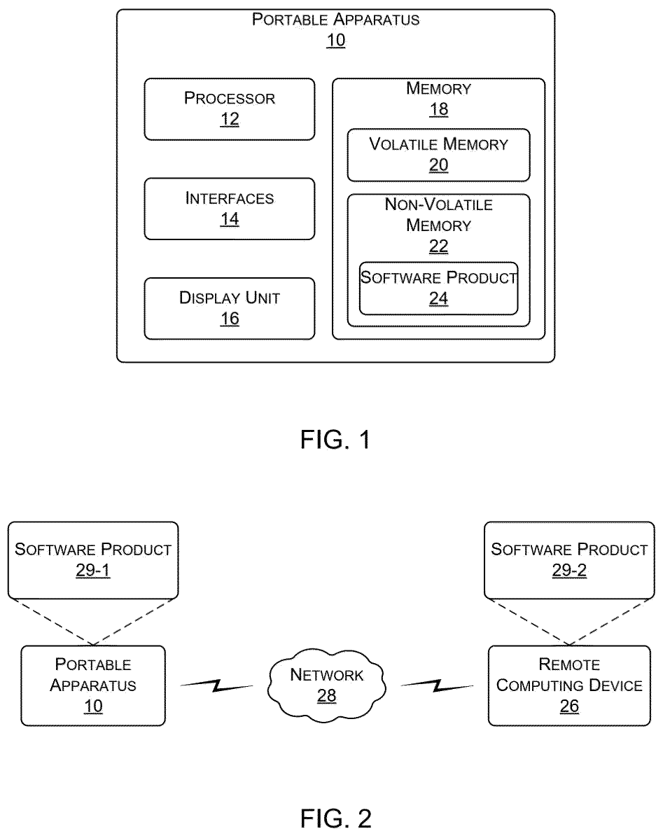

FIG. 1 illustrates an exemplary portable apparatus 10 for responsive feedback management, according to an embodiment of the present application. In one embodiment, the portable apparatus 10 may include a processor 12, interfaces 14, a display unit 16, and a memory 18. The portable apparatus 10 may be implemented by way of a single device (e.g., a computing device, a processor, or an electronic storage device) or a combination of multiple devices that may be operatively connected or networked together. For example, the portable apparatus 10 may include a first device including a display unit 16 and a second device including physical or digital keys or buttons. Each of the keys may be configured to provide an input to the second device and/or to the first device. The first device may be removably attached or formed integral to the second device. The first device may have a wired or wireless connection with the second device. In some examples, the first device may include an opening (e.g., slot, sleeve, recess, etc.) to receive the second device. In some other examples, the first device or the second device may include ports or slots to physically receive or operatively couple with a third device. In further examples, one or more of the first device, the second device, and the third device (collectively referred to as sub-devices) may include one of a computing device (or the processor 12) and a computer memory, such as the memory 18. The sub-devices may have a mechanical or an electrical connection between them. Other examples may include any of the sub-devices corresponding to or including an electronic component, a non-electronic component, or an electromechanical component.

The portable apparatus 10 may include hardware and installed software compatible therewith. The hardware may be closely matched to the requirements and functionality of the software to enable or perform an intended function. Examples of the function may include but are not limited to (1) generating a pulsed signal, (2) initiating a trigger event relating to an operation, (3) initiating or inhibiting a component, (4) providing an indication related to an operation, and (5) performing an operation independently or in communication with a networked device.

In one embodiment, the processor 12 may be configured to execute machine-readable program instructions to (1) communicate synchronously or asynchronously with one or more software applications, databases, storage devices, computing device, or network appliances operating via same or different communication protocols, formats, database schemas, platforms or any combinations thereof, to send and receive data pertaining to, without limitation, user inputs and user data, clock times, time durations, hash values, machine-readable indicia, images, passcodes, network data, data verification files, software or network configuration files, software product, and software patches; (2) collect, define, store, analyze, and update data; (3) formulate one or more tasks for being performed on the data; (4) configure, execute, switch, inhibit, and communicate one or more modes of operation; (5) display, print, or communicate data; (6) transfer or share data including tasks, functions, metadata, metadata tags, and related values, or any combinations thereof, to one or more networked computing devices or data repositories; (7) receive or generate pulsed signals; (8) initiate or inhibit operation of components; and (9) introduce or manage a delay in generation or receipt of signals or data.

The “hardware” may comprise a combination of discrete components, an integrated circuit (IC), an application-specific integrated circuit, a field programmable gate array, a digital signal processor, or other suitable hardware. The “software” may comprise one or more objects, agents, threads, lines of code, subroutines, separate software applications, two or more lines of code or other suitable software structures operating in one or more software applications or on one or more processors. The processors, such as the processor 12, may include, for example, microprocessors, microcomputers, microcontrollers, digital signal processors, central processing units, state machines, logic circuits, and/or any devices that manipulate signals based on operational instructions. Among other capabilities, the processor 12 may be configured to fetch and execute machine-readable instructions in a dedicated or shared memory operatively associated with the portable apparatus 10 for performing tasks such as signal coding, data processing, I/O processing, power control, and/or other functions.

The processor 12 may be configured to control various components and operations of the portable apparatus 10, or devices operationally connected thereto. The processor 12 may control these components or perform the operations based one or more predefined or dynamically defined operational modes, discussed below in greater detail. In some examples, the processor 12 may operate in communication with a software product 24 adapted to control or configure one or more aspects of the portable apparatus 10. The software product 24 may include system software or a software application loaded on a computer readable medium. Examples of the software application may include, but are not limited to, a computer application, a web application, and a mobile application. In some instances, the software application may include the system software, or vice versa. Examples of the system software may include, but are not limited to, operating system, device drivers, firmware, utility software, programming language translators, bootloader, shells, and hypervisors.

In one embodiment, the software product 24 may include or communicate with a software patch (not shown). In one example, the software patch may operate to modify or assist in implementing or configuring an aspect (e.g., installation, uninstallation, synchronization, general or specialized operation, etc.) of the software product 24 or that of the portable apparatus 10. The software product 24, independently or in combination with the software patch, may adjust a parameter value to manipulate a function or data related to the portable apparatus 10. In some examples, the adjusted parameter value may manipulate a function and/or input or output (I/O) data of a remote computing device operatively connected to the portable apparatus 10. For instance, the software product 24 may provide an interface between the processor 12 and a circuit (not shown) of the portable apparatus 10 to perform an intended function or operation. In some instances, the software patch may inhibit (or stop) an operation performed by the portable apparatus 10 and/or the software product 24. Both the software patch and the software product 24 may be installed on the same apparatus such as the portable apparatus 10; however, some examples may include the software product 24 and the software patch being installed on different storage or computing mediums.

Further, the portable apparatus 10 may include one or more suitable types of interfaces 14 known in the art, related art, or developed later. Examples of the interfaces 14 may include software interfaces (e.g., driver interfaces, application programming interfaces, graphical user interfaces, etc.) and hardware interfaces (e.g., cable connectors, physical or digital keys, card readers, barcode readers, cameras, radio frequency identity (RFID) readers, biometric scanners, interactive display screens, button-based interfaces, transceiver or network circuits, etc.); or both. The interfaces 14 may assist the portable apparatus 10 to physically interact with users and/or communicate with networked devices.

The portable apparatus 10 may further include the memory 18 for storing, at least one of: (1) files and data including metadata, e.g., data size, data format, creation date, names, addresses, contact information, associated tags or labels, etc.; (2) a log of profiles of users, feedback terminals, network service set identifiers (SSIDs), and network devices including related communications such as instructions, queries, data, and related metadata; and (3) predefined or dynamically defined, calculated, manipulated, or used data for, without limitation, (i) display, (ii) processing; (ii) updating counter values; (iii) managing timers; (iv) analysis of signals and responses related thereto; (v) clock times and related durations and time standards; (vi) proximity computations; (vii) generating hash values and related datasets; (viii) remote and local notifications; and so on. The memory 18 may include any suitable computer readable medium known in the art, related art, or developed later. In one example, the memory 18 may include a volatile memory 20 (e.g., RAM, cache memory, etc.) and a non-volatile memory 22 (e.g., flash memory, solid state drive etc.). In some examples, the memory 18 may include one or more databases, which may be sub-divided into further databases for storing electronic files and data. The portable apparatus 10 may perform one or more operations on the data. The portable apparatus 10 may communicate an accessed data or a resultant data generated during an operation to one or more networked computing devices. Examples of data operations may include, but are not limited to, reading, writing, deleting, indexing, segmenting, labeling, tagging, updating, mapping, and manipulating the data, or any combinations thereof. The data or aspects related thereto may be displayed on a user interface of the display unit 16.

The display unit 16 may operate in communication with the processor 12 or a network of devices comprising the processor 12. The display unit 16 may indicate, either independently or in communication with a remote user interface, information pertaining to a function of the portable apparatus 10 or an operation performed using the portable apparatus 10. In one example, the display unit 16 may represent or include a low-power display device. Other examples may include the display unit 16 comprising an interactive display screen assisting a user in accessing, controlling, or dynamically configuring different functions of the portable apparatus 10. The display unit 16 may display a dashboard indicating a list of one or more functions, operational modes, parameters or values thereof, notifications, machine-readable indicia, status indicators, etc. The dashboard may display various types of static content (e.g., text, images, icons, logos, etc.) and dynamic content (e.g., avatars, graphical indicia, notifications, etc.), in any suitable combination. The dashboard, in some examples, may be modifiable in response to or for an operation performed using the portable apparatus 10. Other examples may comprise the display unit 16 including or operating in communication with any of a variety of tangible indicators (e.g., light sources, vibrators, display units, projectors, speakers, etc.) or virtual/intangible indicators displayable on the dashboard, or any other components. The display unit 16 may be mounted to the portable apparatus 10 or located remote therefrom. In some examples, the display unit 16 may be located on a remote device and operatively coupled to the portable apparatus 10.

As illustrated in FIG. 2, the portable apparatus 10 may be configured to operate in communication with a remote computing device 26 over a network 28. The network 28 may include, for example, one or more of the Internet, Wide Area Networks (WANs), Local Area Networks (LANs), analog or digital wired and wireless telephone networks, cellular networks, Wi-Fi™ networks, satellite, and/or any other delivery or tunneling mechanism for carrying data. The network 28 may include multiple networks or sub-networks, each of which may include, e.g., a wired or wireless data pathway. The network 28 may support voice, video, and data communications using any suitable communication protocols known in the art. Examples of the remote computing device 26 may include, but are not limited to, servers, mobile phones, laptops, network appliances, and another apparatus similar to the portable apparatus 10, or any combinations thereof. Examples of the network appliances may include, but are not limited to, a DSL modem, a wireless access point, a router, a signal repeater or enhancer, and a gateway having a predetermined computing power and memory capacity to implement an intended software product.

In one embodiment, the portable apparatus 10 may include a first software product 29-1 and the remote computing device 26 may include a second software product 29-2. Each of the first software product 29-1 and/or the second software product 29-2 (hereinafter collectively referred to as software products 29) may assist the respective hardware to communicate with each other. For example, the first software product 29-1 may enable the portable apparatus 10 for being introduced to the remote computing device 26, thereby enabling the remote computing device 26 to invoke or use the portable apparatus 10, or local resources thereof, as a service. Similarly, the second software product 29-2 may enable the remote computing device 26 for being introduced to the portable apparatus 10, thereby enabling the portable apparatus 10 to invoke or use the remote computing device 26, or local resources thereof, as a service. Examples of the local resources may include, but are not limited to, device resources (e.g., power, storage, network connectivity, processing power, display, etc.), hardware resources (e.g., processors, battery, memory, ports, display screen, etc.), and software resources (e.g., system software, software application, etc.). Some examples may include the portable apparatus 10 configured to include or use a software product, such as any of the software products 29, installed or integrated with another device. Each of the software products 29 may be implemented or configured to be of the same type or different types. Aspects of the portable apparatus 10 may also be implemented on a remote computing device such as a server 110. One having ordinary skill in the art would understand that aspects of the remote computing device 26, such as the server 110, described in the present application may be performed using the portable apparatus 10, or any modules thereof in communication, wholly or in-part, with or without the remote computing device 26. For example, any or all aspects of the server 110 may be performed or implemented independently using the portable apparatus 10 or any modules operatively associated therewith, or vice versa.

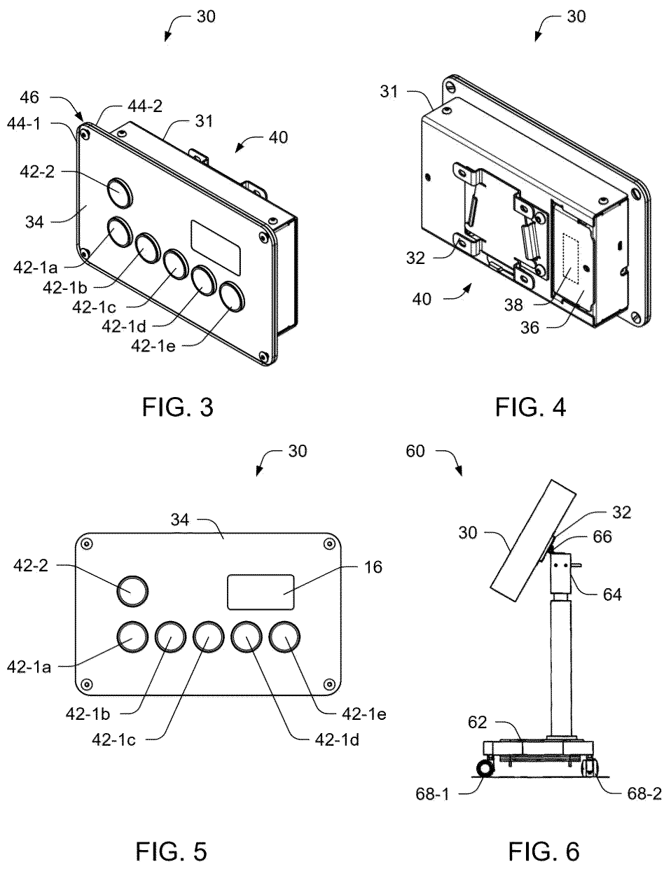

FIGS. 3-5 illustrates the portable apparatus 10 configured as an exemplary handheld terminal 30, according to a first embodiment of the present application. The handheld terminal 30 may have any suitable shape and dimensions to support or mount various operational components therewith and to promote better grip in the hands of a user. The handheld terminal 30 may include a housing 31, a mounting bracket 32, and a panel 34. The housing 31, either alone or in combination with the panel 34, may enclose or support one or more operational components, such as the processor 12. The housing 31 may include one or more compartments. For example, as shown in FIG. 4, the housing 31 may include a compartment 36 to removably dispose a battery 38 therein. Such battery compartment 36 may be separate or partitioned from other operational components, such as the processor 12 and the display unit 16. The housing 31 may be made out of any suitable materials known in the art including, but not limited to, metals, polymers, glass, quartz, alloys, or any combinations thereof that are sufficiently rigid and durable to support the operational components. The housing 31 may include a front side (not shown) and a rear side 40. In the illustrated example (FIG. 4), the front side and the rear side 40 may be opposite to each other. The rear side 40 may include a mounting bracket 32 to removably mount the housing 31 (or the handheld terminal 30) on to an intended surface, such as a wall or an apparatus. The front side of the housing 31 may be detachably secured to the panel 34.

As illustrated in FIG. 5, the panel 34 may provide an interface to facilitate and encourage a user to interact with the handheld terminal 30. In one embodiment, the panel 34 may include a set of hardware push-buttons 42-1a, 42-1b, 42-1c, 42-1d, 42-1e, and 42-2 (hereinafter collectively referred to as push-buttons 42) and the display unit 16. Each of the push-buttons 42 may correspond to a physical press button or a mechanical switch. Further, some examples may include a light source (not shown) operationally coupled to one or more of the push-buttons 42. For instance, a button press may cause the corresponding light source to activate for a preset duration. In some examples, the light source may be integrated or packaged together with the corresponding push-buttons 42. The light source may be disposed adjacent to the corresponding push-buttons 42 and the display unit 16. Examples of the light source may include, but are not limited to, light emitting diodes (LEDs), bulbs, and lamps. Some examples may include the panel 34 having a touch screen (not shown) including digital buttons operating similar to the push-buttons 42. The touch screen may include the display unit 16 or disposed separate therefrom. In some examples, the display unit 16 may include one or more portions configured to have varying luminance based upon (i) receiving a trigger signal and/or (ii) manipulation of the push-buttons 42 (or the digital buttons). Compared to digital buttons, the push-buttons 42 may provide a more satisfying tactile feedback and sensory experience to encourage a user to interact with the handheld terminal 30.

When manipulated, the push-buttons 42 may be configured by the processor 12 in communication with the software product 24 to provide pulsed signals. For example, a push-button may be set up to provide a pulsed signal upon being pressed. In another example, a push-button may be configured to provide a pulsed signal upon release after being pressed. The push-buttons 42 may be physically pressed by a user to provide the corresponding pulsed signals. However, some examples may include the processor 12 manipulating the push-buttons 42 to automate generation of the corresponding pulsed signals. The processor 12 may cause the one or more of the push-buttons 42 to generate the corresponding signals via software calls and/or in communication with appropriate hardware.

Each of the push-buttons 42, or the corresponding pulsed signal, may indicate (or be interpreted by the processor 12 as) providing a trigger to perform an action for an intended purpose. Examples of the action may include, but are not limited to, initiating or inhibiting a function or an operation related thereto, set or adjust a parameter value, and toggle an operational mode (or an operational state) of the portable apparatus 10 or any components coupled thereto. In some examples, the pressing of one or more push-button, either individually or in a set combination, may cause the processor 12 to indicate or record a set number, a set alphabet, a set string, or a set data type, or any combinations thereof.

In one embodiment, the panel 34 may be formed as a single part, which may be mounted to the housing 31 using any suitable connection mechanisms known in the art. The panel 34 may include one or more openings. For instance, the panel 34 may include a primary opening (not shown) and a secondary opening (not shown). The primary opening may have suitable dimensions to receive the display unit 16 in either a landscape orientation or a portrait orientation. The secondary opening may correspond to a single opening or a set of multiple distinct openings. The secondary opening may be configured to receive one or more hardware, such as the push-buttons 42. Some examples may include the secondary opening configured to receive one or more button covers (not shown) mounted to the panel 34, where each button cover may align with a push-button disposed thereunder or under the panel 34. When pressed, the button covers may engage and assist in driving the respective push-buttons.

In another embodiment, the panel 34 may be formed as a set of parts assembled together. For example, the panel 34 may include a first portion 44-1 and a second portion 44-2 (hereinafter collectively referred to as panel portions 44). The panel portions 44 may be detachably coupled to each other and/or to the housing 31. Each of the panel portions 44 may have the same or different dimensions (e.g., length, breadth, thickness, radius, etc.). The panel portions 44 may include any suitable geometrical shapes (e.g., circular, polygonal, spherical, cylindrical, elliptical, etc.) or non-geometrical shapes (e.g., irregular shapes, ergonomic contours, etc.) depending on the intended panel interface. In one example, the second portion 44-2 may interface between the first portion 44-1 and the housing 31. The panel portions 44 may have a predefined spacing 46 between them. The spacing 46, in one example, may range from approximately 1 millimeter (mm) to approximately 20 mm. The spacing 46 may have any suitable characteristics (e.g., shape, length, width, volume, etc.) to receive a sub-element. Examples of the sub-element may include, but are not limited to, a non-electronic component (e.g., substrates, printable medium, fasteners, etc.) and an electronic component (e.g., display unit, push-buttons, camera, light sources, sensors, processors, etc.). In some examples, the sub-element may be removably coupled or formed integral to one of the panel portions 44. In further examples, at least one of the panel portions 44 may include one or more holes to receive or align with the display unit 16 and other hardware such as the push-buttons 42.

The panel 34 (or the panel portions 44) may have the same or varying degrees of optical permeability. For example, the panel 34 (or any of the panel portions 44) may include a gradient of transparency across its surface ranging from being fully transparent to being fully opaque. In another example, the first portion 44-1 and/or the second portion 44-2 may include a transparent section with or without a non-transparent section (e.g., opaque, partially opaque, translucent, etc.). The transparent section may assist in exposing the sub-element disposed proximate thereto. In further examples, the panel 34 or any portions thereof may be optically permeable to a specific wavelength (e.g., 590 nm, 600 nm, 620 nm, etc.) or a specific wavelength range (e.g., 10 nm to 400 nm, 590 nm to 620 nm, 400 nm to 700 nm). Other examples may include the panel 34 or any portions thereof having one or more sections that may be textured and/or reflective. The panel 34 or any portions thereof may be made using any suitable panel materials known in the art that may be the same or different from those used for the housing 31. Examples of the panel 34 materials may include, but are not limited to, glass, metals, polymers, fiberglass, quartz, alloys, or any combinations thereof.

The panel 34 (or the housing 31) may enclose or support the display unit 16. In one embodiment, the display unit 16 may include, or correspond to, a low-power display such as an electronic ink display device; however, other suitable types of low-power displays known in the art may also be implemented. The electronic ink display device may reduce or eliminate the need to refresh frequently to display a stable output such as data and image, leading to lower power consumption, reduced battery discharge, and extended battery life. The electronic ink display device, the push-buttons 42, and the battery 38, including related data and circuits, may be controlled by the processor 12.

In a second embodiment (FIG. 6), the portable apparatus 10 may be configured as a mobile terminal 60. As illustrated, the mobile terminal 60 may include the handheld terminal 30 removably coupled to a mobile platform 62 or a portion connected thereto. In one example, the handheld terminal 30 may be fixedly mounted to a support arm 64 coupled to the mobile platform 62 via the mounting bracket 32. The support arm 64, in some instances, may include or correspond to an articulated arm (e.g., robotic arm). In another example, the handheld terminal 30 may be movably mounted to the support arm 64 via a movable joint 66. Examples of the movable joint 66 may include, but are not limited to, hinge joint, pivot joint, and ball-and-socket joint. The movable joint 66 may be implemented via suitable hardware (e.g., bracket) providing one or more degrees of freedom to the handheld terminal 30. The movable joint 66 may facilitate a translatory or rotary motion of the handheld terminal 30 (or the housing 31) relative to the support arm 64 or the mobile platform 62. In some examples, the movable joint 66 (or the handheld terminal 30) may be movable electronically using the processor 12.

Further, the mobile platform 62 may include wheels 68-1 and 68-2 (collectively, wheels 68) to manipulate a pose (i.e., position and orientation) of the mobile terminal 60 (or the handheld terminal 30). The wheels 68 may be configured to move the mobile terminal 60 a desired manner (e.g., sideways, forward, rotate, backward, reverse, etc.) to an intended position or orientation. The mobile platform 62 (or the wheels 68) may be motorized or made autonomous for automated mobility of the mobile terminal 60. The mobile platform 62 (and the handheld terminal 30) may be controlled by the processor 12; however, some examples may include a separate control unit (not shown) to operate the mobile terminal 60. The control unit (and in some examples, the processor 12) may be disposed in the mobile platform 62. The control unit may operate independently or in tandem with the processor 12 to control one or more aspects of the mobile terminal 60. In some examples, the control unit (or the processor 12) may operate in communication with the remote computing device 26 to control such aspect of the mobile terminal 60. Examples of such aspect may include, but are not limited to, network data transfer, live location tracking, autonomous mobility, remote-controlled mobility, and relative movements of the handheld terminal 30 and the mobile platform 62. In a third embodiment (not shown), the portable apparatus 10 may be integrated with or implemented using a wearable device. Examples of the wearable device may include, but are not limited to, a fashion accessory (e.g., wristbands, watches, rings, bracelets, pendants, etc.), a utility device (e.g., portable speakers, remote controllers, electronic testers, pen drives, etc.), a body clothing (e.g., gloves, jackets, vest, etc.), and a safety gear (e.g., helmets, goggles, face shield, belts, etc.), or any combinations thereof.

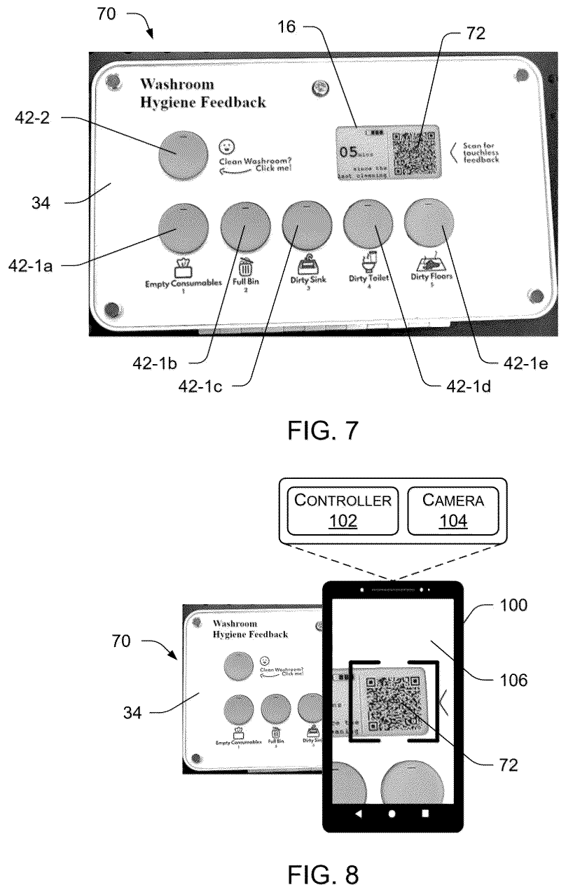

The portable apparatus 10 may be configured to receive, indicate, or process inputs based on intended applications. In one embodiment, as illustrated in FIG. 7, the portable apparatus 10 may be configured as a handheld feedback terminal 70 (or feedback terminal 70) for washroom hygiene management. In the present application, the functionality of the feedback terminal 70 has been explained in the context of receiving user feedback/inputs in response to user's perceived hygiene in the washroom. However, one having ordinary skill in the art would understand that feedback terminal 70 and the concepts described in the present application may be adapted for use in the other contexts and applications. For example, the feedback terminal 70 may be adapted to communicate with electronic tags or sensing devices including sensors and/or transceivers connected to various fixtures (e.g., sink, toilet seat, faucet, etc.), accessories (e.g., toilet roll holder, towel rack, bins, etc.), and equipment (e.g., soap dispenser, hand dryer, bidet, etc.) in a washroom.

The feedback terminal 70 may have the functionality and structure similar to that discussed above for the handheld terminal 30. In the illustrated example of FIG. 7, the feedback terminal 70 may include the push-buttons 42, or the corresponding pulsed signals provided therefrom, being configured to indicate (or be interpreted by the processor 12 as) user inputs and/or activities related to the washroom. For instance, the push-button 42-1a may be configured to indicate “Empty Consumables”, the push-button 42-1b may be configured to indicate “Full Bin”, the push-button 42-1c may be configured to indicate “Dirty Sink”, the push-button 42-1d may be configured to indicate “Dirty Toilet”, and the push-button 42-1e may be configured to indicate “Dirty Floors”. Further, the push-buttons 42-1a, 42-1b, 42-1c, 42-1d, 42-1e (hereinafter collectively referred to as issue buttons 42-1) may indicate one or more issues related to an indoor location such as the washroom. In some examples, the issue buttons 42-1 may be associated with numbers, such as ‘1’, ‘2’, ‘3’, ‘4’, and ‘5’ respectively. Some examples may include any of the issue buttons 42-1 (or the corresponding pulsed signals) being configured to be associated with or indicate an alphanumerical value, an alphabet, a string, a symbol, and a signal attribute (e.g., identifier (ID), number of signal pulses, frequency, duration, voltage, current), or any combinations thereof, depending on different operational modes, discussed below in detail, of the feedback terminal 70.

Similarly, in the illustrated example (FIG. 7), the push-button 42-2 may be configured as a non-issue button 42-2. For example, the push-button 42-2 may be designated as a smiley button. Upon manipulation, the push-button 42-2, or a pulsed signal provided therefrom, may indicate or register an emotional state of a user in response to ambient conditions in the washroom. For example, when pressed, the push-button 42-2 may indicate a user feeling happy or satisfied with the current state of hygiene in an indoor location such as the washroom. The push-buttons 42 may be pressed individually or in a preset combination with each other to provide a trigger signal. For example, any of the issue buttons 42-1 may be pressed individually to provide the trigger signal. In another example, a set of issue buttons 42-1 may be pressed together in a preset combination to provide the trigger signal. Other examples may include any of the issue buttons 42-1 pressed together with the non-issue button 42-2 in a preset combination to provide the trigger signal.

The trigger signal may initiate a trigger event for the feedback terminal 70. The trigger event may be configured to (i) manipulate a state of a component, (ii) initiate, terminate, or toggle an operational mode, (iii) process, store, or transfer data, and (iv) provide an indication, or any combinations thereof. Examples of the indication may include, but are not limited to, actuation or toggling of tangible indicators (e.g., light emitting diodes, vibrators, sensors, speakers, etc.), virtual indicators displayable on the dashboard (e.g., numeric indicators, alphanumeric indicators, or non-alphanumeric indicators, such as different colors, different color luminance, different patterns, different textures, different graphical objects, etc.), or any other suitable types of audio, visual, textual, and haptic indicators known in the art, related art, or developed later.

Further, the feedback terminal 70 may include a processor, such as the processor 12, configured to process data for display on the display unit 16. Examples of such data may include, but are not limited to, operational modes, status of use (e.g., clock time, time elapsed since manipulation of an operational mode, signal strengths, etc.), status of component (e.g., remaining battery, input or output (I/O) voltage, I/O current, etc.), and machine-readable indicia and data related thereto. In some examples, the processor 12 may be configured to process data related to a remote computing device 26, such as those mentioned above, for display on the display unit 16.

In one embodiment, the feedback terminal 70 may include any of a variety of machine-readable indicia. For example, as illustrated in FIG. 7, the feedback terminal 70 includes a quick response (QR) code 72 displayed on the display unit 16. Other examples of the machine-readable indicia may include, but are not limited to, data matrix codes, Aztec codes, PDF417 codes, Snapcodes™, and Augmented Reality (AR) tags. In the present application, aspects of the feedback terminal 70 are explained in relation to QR codes. However, one having ordinary skill in the art would understand that the concepts described in the present application can be applied or adapted for use with other types of machine-readable indicia.

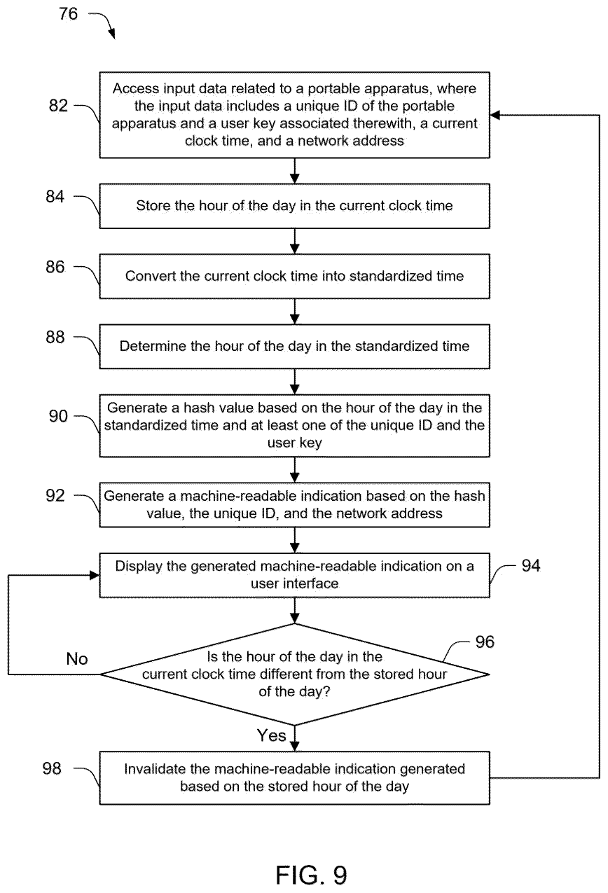

The QR code 72 may assist a user to perform one or more functions of the feedback terminal 70 on a remote computing device 26, such as those mentioned above. For example, the QR code 72 may assist a user in providing feedback (or input) based on the perceived hygiene in an indoor location such as a washroom, remotely. The processor 12 may implement an exemplary method 76 illustrated in FIG. 9 to generate a dynamic, secure QR code, such as the QR code 72. The order in which the method 76 is described is not intended to be construed as a limitation, and any number of the described method blocks may be combined, deleted, or otherwise performed in any order to implement the method 76 or an alternate method without departing from the concepts described in the present application. The exemplary method 76 may be described in the general context of computer-executable instructions, which may be stored on a computer readable medium, and installed or embedded in an appropriate device for execution. Further, the method 76 may be implemented in any suitable hardware, software, firmware, or combination thereof, that exists in the related art or that is later developed.

At step 82, input data related to a feedback terminal 70 is accessed. In one embodiment, the processor 12 may be configured to receive or access input data related to the feedback terminal 70. In one example, the input data may be stored in the memory 18. Some examples may include the input data or a part thereof being determined or received by the processor 12 in communication with the remote computing device 26. The input data may include a unique identifier (ID) of the feedback terminal 70, a user key, a current clock time, and a network address of a remote computing device. Examples of the unique ID may include, but are not limited to, device ID, medium access control (MAC) address, International Mobile Equipment Identity (IMEI) number, universally unique identifier (UUID), and serial number. In some examples the unique ID may include one of an IC number and a part number associated with a component of the feedback terminal 70. Other examples may include the unique ID corresponding to a software product ID of a software product (or a software patch) installed on the feedback terminal 70.

The processor 12 may access or receive the user key associated with the unique ID. In one embodiment, the user key may represent or include a unique key related to a user profile associated with the portable apparatus 10 such as the feedback terminal 70. The user profile may represent or include a collection of data and information related to a user (i.e., user data). In some examples, the user profile may include a reference to user data. Other examples may include the user profile comprising metadata related to the user data. Examples of the user data may include, but are not limited to, name data (e.g., legal name, organization name, avatar name, nickname, etc.), location data (e.g., registered address, mailing address, residential address, city, state, country, zip code, geographical location, location ID, location name (e.g., office name, room name, etc.), GPS coordinates, etc.), contact data (e.g., email address, phone number, uniform resource locator (URL), domain name, IP address, uniform resource name (URN), hyperlink, facsimile number, WhatsApp™ ID, and social media handles, etc.), and login data (e.g., login name, IP address of login device, browser type, operating system on login device, login or access time, logout time, session duration, user preferences, etc.),

The user profile may include a single profile or a set of multiple profiles. The user profile may include one more of the same or different types of profiles. Examples of user profile types may include, but are not limited to, email account profile, social media profile, subscription profile, data storage profile, customer or client profile, customer support profile, account login profile, administrator profile, guest administrator profile, moderator profile, guest profile, service account profile, custodian profile, user role profile, and end-user profile.

In one embodiment, the processor 12 may be configured to create the user key based on the user profile, (ii) user data, and (iii) metadata related to the user data, or any combinations thereof. Examples of metadata related to user data may include, but are not limited to, creation date, file or data size, file or data format, version history, modification history, content type (e.g., text, image, audio, video, etc.), content tags or keywords, data ownership, access permissions, data source information, associated application metadata, hash, and natural language of data (e.g., “English”, “Spanish”, “Mandarin”, etc.). The user key may be stored locally in the memory 18 of the portable apparatus 10 such as the feedback terminal 70. In some examples, the processor 12 may receive or access the user key stored on a remote computing device such as those mentioned above over the network 28. Examples of the user key may include, but are not limited to, cryptographic key (e.g., public key or private key), hash, serial numbers, and metadata tags.

The processor 12 may further access or receive the current clock time of the portable apparatus 10 such as the feedback terminal 70. In one embodiment, the current clock time may relate to a specific time of the day. The current clock time may be recorded, maintained, stored, or presented in a preset local time standard. Examples of the local time standard may include, but are not limited to, Coordinated Universal Time (UTC), Greenwich Mean Time (GMT), Eastern Standard Time (EST), Eastern Daylight Time (EDT), Pacific Standard Time (PST)/Pacific

Daylight Time (PDT, Indian Standard Time (IST), International Atomic Time (TAI), and China Standard Time (CST). The current clock time may include the hour, the minute, and the second of the day in a preset time format. The current clock time may be recorded or presented in a 24-hour format (e.g., “14:30:15”) or a 12-hour format with AM/PM (e.g., “2:30:15 PM”). In some examples, the current clock time may include a date on the day.

The processor 12 may be operatively coupled to a clock source (not shown) and configured to generate and maintain a clock time based on a reference signal from the clock source. In some examples, the current clock time may represent an internal clock time (or system time) of the portable apparatus 10 such as the feedback terminal 70. Other examples may include the current clock time representing an internal clock time (or system time) of a component operationally connected to the feedback terminal 70.

Further, the processor 12 may access or receive the network address of a remote computing device, such as those mentioned above. The network address may represent a destination address (or network location identifier) associated with a network device. The network address may facilitate identifying, locating, and connecting to the network device associated therewith for data routing and communication. For instance, a first computing device (e.g., mobile phone) may use the network address to connect with the corresponding second device (e.g., server). In one example, the network address may be associated with (or facilitate access to) a remote computing device, such as those mentioned above, hosting an intended webpage. In another example, the network address may be associated with (or facilitate access to) a proxy remote computing device, such as those mentioned above, including a reference to a remote device hosting the intended webpage. In one embodiment, the webpage may include or feature a digital replica 120 of the portable apparatus 10, such as the feedback terminal 70, discussed below in greater detail. Examples of the network address may include, but are not limited to, a URL, hyperlink, domain name, URN, and an IP address. The network address may be stored in the memory 18 by the processor 12.

At step 84, the hour of the day in the current clock time is stored. In one embodiment, the processor 12 may be configured to (i) determine the preset time format (e.g., 12-hour or 24-hour format, time zone, etc.) of the current clock time and (ii) store the hour of the day in the current clock time. For example, if the current clock time (or internal clock time) of the feedback terminal 70 may be “2:30:15 PM” in the 12-hour format, the processor 12 may store “2” as representing the hour of the day in the memory 18, e.g., volatile memory 20. In another example, if the current clock time (or internal clock time) of the feedback terminal 70 may be “14:30:15” in the 24-hour format, the processor 12 may store “14” as the hour of the day in the memory 18, e.g., volatile memory 20.

At step 86, the current clock time is converted into a standardized time. In one embodiment, the processor 12 may be configured to convert the current clock time of the feedback terminal 70 into a predefined standardized time using any suitable methods known in the art. The standardized time may refer to a time represented in a preset common time standard. In one example, the common time standard may refer to an expected local time standard associated with a time recorded, maintained, stored, or presented in a remote computing device associated with the network address. In another example, the common time standard may include a universal time standard, such as UTC and GMT. In further examples, the standardized time may be represented in a predefined time format. For instance, if the current clock time (or internal clock time) of the feedback terminal 70 may be “2:30:15 PM” in the 12-hour format in Eastern Daylight Time (EDT), the processor 12 may convert the current clock time into the corresponding UTC time of “6:30:15 PM” in the 12-hour format. In another instance, if the current clock time (or internal clock time) of the feedback terminal 70 may be “14:30:15” in the 24-hour format in Eastern Daylight Time (EDT), the processor 12 may convert the current clock time into the corresponding UTC time of “18:30:15” in the 24-hour format. Some examples may include the processor 12 configured to directly use the current clock time associated with the feedback terminal 70 without any conversion to the preset common time standard. For example, the processor 12 may be configured to directly use the current clock time upon being associated with a time standard same as that preset for the standardized time. In further examples, the processor 12 may select the common time standard for the standardized time based on a known geographical location or time standard associated with the remote computing device 26 to which the feedback terminal 70 may be connected. For instance, the processor 12 may select UTC as the time standard for the standardized time based on the connected server having an internal clock time in UTC.

At step 88, the hour of the day is determined in the standardized time. In one embodiment, the processor 12 may be configured to determine the specific hour of the day in the standardized time. For example, if the determined standardized time, e.g., in UTC, may be “6:30:15 PM” in the 12-hour format, the processor 12 may determine “6” as the hour of the day. In another example, if the determined standardized time, e.g., in UTC, may be “18:30:15” in the 24-hour format, the processor 12 may determine “14” as the hour of the day.

At step 90, a hash value is determined. In one embodiment, the processor 12 may be configured to generate a hash value based on the input data. For example, the processor 12 may use any suitable hashing algorithms known in the art, related art, or developed later to generate a hash value by using (i) the hour of the day in the standardized time (e.g., UTC time), (ii) the unique ID associated with the portable apparatus 10 such as the feedback terminal 70, and (iii) the user key. In another example, the processor 12 may generate the hash value by using (i) the hour of the day in the standardized time alone or in combination with either the unique ID associated with the feedback terminal 70 or the user key. Other examples may include the processor 12 determining the hash value by using the hour of the day in the internal clock time alone or in combination with the unique ID of the feedback terminal 70 and/or the user key, provided the feedback terminal 70 and the remote computing device 26 associated with the predefined network address may be located in the same time zone (or geographical location) or have their system clocks synchronized with each other over the network 28. Examples of the hashing algorithms may include, but are not limited to, MD5, Blake2, SHA256, SHA512, and SHA3-512. The determined hash value may operate as a security feature and assist in authenticating a request sent to the remote computing device 26 associated with the predefined network address.

At step 92, a machine-readable code is generated. In one embodiment, the processor 12 may be configured to generate a machine-readable indication. For example, the process may generate a QR code based on the generated hash value, the accessed or stored network address, and the unique ID of the feedback terminal 70 (collectively referred to as primary data). In some examples, the processor 12 may also use secondary data in addition to the primary data for generating the QR code 72. Examples of the secondary data may include the user data, such as those mentioned above, related to a specific user. The processor 12 may encode the primary data alone or in combination with the secondary data to generate the QR code 72 using any suitable algorithms known in the art, related art, or developed later.

In the primary data, the network address may provide a reference to an intended webpage (or a website), e.g., featuring a digital replica 120 of the portable apparatus 10 such as the feedback terminal 70. In some examples, the network address may be encoded for use as the network location identifier to connect with a remote computing device associated therewith. Further, the hash value may provide a security feature to validate the QR code 72 on a remote computing device, thereby making the QR code secure.

In one embodiment, the generated secure QR code 72 may correspond to a static machine-readable indication having contents that may remain fixed or unchangeable. For instance, the processor 12 may generate the QR code 72 using a fixed set of primary data and/or secondary data. In another embodiment, the secure QR code 72 may be generated as a dynamic, secure QR code 72 having contents that at least in-part change periodically. For example, the processor 12 may be configured to generate the dynamic, secure QR code 72 including a static primary data and a dynamic secondary data that may change after a set time or duration. In another example, the dynamic, secure QR code 72 may include a static secondary data and a dynamic primary data that changes after a set time or duration. Other examples may comprise the dynamic, secure QR code 72 including both the primary data and the secondary data changing over time.

At step 94, the machine-readable indication is displayed. In one embodiment, the processor 12 may configure and send the generated machine-readable indication to the display unit 16 for display. For example, the processor 12 may configure the QR code 72 for display as one of a two-dimensional (2D) monochrome or colored image, a three-dimensional (3D) monochrome or colored image, and a set of two or more images, or any combinations thereof. In some examples, the processor 12 may configure an image of the QR code 72 to include one or more gaps, e.g., ranging from approximately 1 millimeter (mm) to 5 mm, for display. The QR code 72 may assist in accessing a predefined webpage (or the associated website) or a predefined remote computing device. The display unit 16 may operate in communication with the processor 12 to receive and display the generated QR code 72.

At step 96, the current hour of the day is determined. In one embodiment, the processor 12 may be configured to check the hour of the day in the current clock time at preset intervals. In one example, the preset intervals may range from approximately 1-second to approximately 60 seconds. In each preset interval, the processor 12 may check an hour of the day in the current clock time relative to the hour of the day stored in the memory 18. For example, the processor 12 may compare the current hour of the day and the stored hour of the day to assess the validity of the QR code 72. Based on a comparison, if the hour of the day in the current clock time may be same as the stored hour of the day, the processor 12 may execute step 94 and continue to display the previously generated QR code. If, however, the hour of the day in the current clock time may be different from the stored hour of the day, the processor 12 may execute step 98. Such comparison may assist the processor 12 to periodically update or generate the new hash value at set intervals, e.g., every hour, for implementing the dynamic, secure QR code 72.

At step 98, the machine-readable indication is invalidated. In one embodiment, the processor 12 may invalidate the machine-readable indication based on the hour of the day in the current clock time being different from the stored hour of the day. For example, the processor 12 may be configured to invalidate the QR code 72 that may be generated based on the stored hour of the day. Other examples may include the processor invalidating the QR code 72 generated based on any hour of the day that may be different from the hour of the day in the current clock time.

The processor 12 may then proceed to execute the steps 82-98 again to (i) generate a new hash value based on a change in the hour of the day in the current clock time of the feedback terminal 70, (ii) generate a new dynamic secure QR code 72 based on the new hash value and at least one of the unique ID of the feedback terminal 70 and the predefined network address stored in the memory 18, (iii) invalidate any previously generated QR code displayed on the display unit 16, and (iv) replace the invalidated QR code with the new dynamic secure QR code 72 on the display unit 16. In some examples, the processor 12 may cause to update and convert the invalidated QR code into the new dynamic secure QR code 72 based on the change in the hour of the day in the current clock time of the feedback terminal 70, as discussed above. Thus, the processor 12 implements the dynamic, secure QR code 72 that may remain valid for a set period of time, such as 1-hour, and expire thereafter based on a change in the hour of the day in the current clock time. The step of invalidating the secure QR code 72 may assist in (i) minimizing the risk of unauthorized access or misuse of the displayed machine-readable indication (e.g., the QR code 72) to initiate a related function, such as access to a predefined webpage and providing feedback, (ii) reducing the computational load as well as usage of system resources (e.g., memory, battery, network bandwidth, cooling system, etc.) on the remote computing device 26 that may be tasked with enabling one or more functions of the feedback terminal 70 via a remote interface based on the QR code 72, and (iii) preventing users from encountering “link rot” upon scanning the QR code 72, e.g., due to a software update (e.g., firmware update) on the feedback terminal 70. In one example, the “link rot” may refer to a condition where data (e.g., a link, a content, etc.) in the QR code 72 may no longer be available, accessible, or has become outdated. The method of FIG. 9 may assist in implementing the dynamic, secure QR code 72 that may be updated or replaced at set intervals, e.g., every hour. Other examples may include the processor 12 being configured to generate a new hash value after a set period, which may be less than an hour or greater than an hour to dynamically update or replace the existing QR code for display.

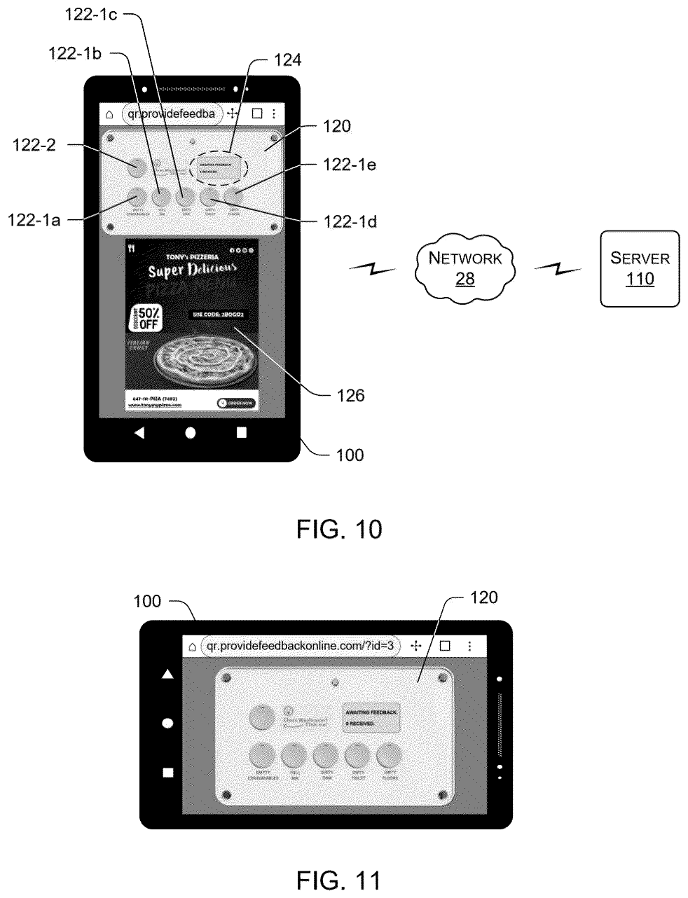

Further, as illustrated in FIG. 8, the dynamic, secure QR code 72 may be scanned using a first remote device, such as a mobile phone 100. In one embodiment, the mobile phone 100 may include a controller 102, a camera 104, and a display screen 106 providing a user interface. The controller 102 may include any suitable hardware, such as those mentioned above. The camera 104 may operate in communication with a local software product (not shown) to scan a QR code, such as the QR code 72. The local software product (e.g., mobile app, computer application, online software, etc.) may be installed on or accessed via the mobile phone 100. The controller 102, either independently or in communication with the local software product (e.g., mobile App), may process and extract data from the scanned QR code 72. In one example, the QR code data may include the generated hash value, the unique ID of the portable apparatus 10 such as the feedback terminal 70, and the predefined network address of a second remote computing device, such as the server 110 (FIG. 10). As illustrated in FIG. 10, the controller 102 may establish a connection with the server 110 over the network 28 based on the predefined network address in the QR code data. The server 110 may be linked to the predefined network address in the QR code data. Upon establishing the connection, the controller 102 may send a service request (e.g., HTTPS request, API request) to the server 110 over the network 28. The service request may include the QR code data or any portions thereof. For instance, the service request may include the hash value, the unique ID of the feedback terminal 70, the predefined network address of the server 110, and an IP address of the mobile phone 100.

The server 110 may receive and authenticate the service request. In one embodiment, the server 110 may authenticate the received server request using the hash value received therewith. For example, the server 110 may maintain a database including one or more unique IDs of various feedback terminals and one or more user keys associated therewith. The server 110 may also create and maintain a log of reference hash values. Each of the reference hash values may be generated and stored by the server 110 based on (i) the hour of the day in the standardized time (such as UTC time) corresponding to the current clock time at the server 110 and at least one of the (ii) the unique ID of the feedback terminal 70 and (iii) a user key associated therewith. The log of reference hash values may be updated at regular intervals (e.g., ranging from approximately 1-second to approximately 1-minute). The server 110 may compare the hash value received in the service request with each of the reference hash values in the log for authentication. Upon comparison, the server 110 may set the received hash value as successfully verified if there is a match, and may reject the service request (or send back a “not verified” response) if there may be no match based on the comparison. On the other hand, when the received hash value may be successfully verified, the server 110 may select a user key associated with the unique ID, which may be received with the service request. In one example, the selected user key may be associated with a set user profile in the database on the server 110. The server 110 may then transmit a service response (e.g., HTTP/HTTPS response, API response) back to the IP address of the mobile phone 100 via the network 28. The service response may include a webpage associated with the selected user key, along with other linked resources such as CSS, JavaScript files, and images.

The mobile phone 100 may receive the service response from the server 110. In one embodiment, the server response may be handled by the controller 102 or the local software product operatively coupled thereto on the mobile phone 100. The controller 102 may parse the service response to obtain, e.g., the HTML content and any other additional resources (e.g., CSS, JavaScript, images, etc.) to render, e.g., the HTML webpage on the user interface in the display screen 106 of the mobile phone 100 via a browser.

In one embodiment, as illustrated in FIG. 10 and FIG. 11, the HTML webpage may include a digital replica 120 of the feedback terminal 70. In some examples, the webpage may include a digital apparatus including the digital replica 120. The digital replica 120 may represent or include an interactive digital representation of the portable apparatus 10 such as the feedback terminal 70. The digital replica 120 may be associated with the unique ID of the feedback terminal 70 received via the scanned QR code (and/or the service request). The digital replica 120 (or the digital apparatus) may have substantially the same appearance or resemblance to the corresponding feedback terminal 70. For example, the digital replica 120 may include digital buttons 122-1a, 122-1b, 122-1c, 122-1d, 122-1e, and 122-2 (hereinafter collectively referred to as digital buttons 122) and a virtual display unit 124. Each of the digital buttons 122 may look and operate similar to the push-buttons 42 of the feedback terminal 70 respectively. In one example, the digital buttons 122-1a, 122-1b, 122-1c, 122-1d, 122-1e (digital buttons 122-1) may be configured as issue buttons 122-1 and the digital button 122-2 may be configured as the virtual smiley button, similar to the push-buttons 42 on the physical feedback terminal 70. The virtual display unit 124 may also display messages when the digital buttons 122 may be clicked. In some examples, the digital buttons 122 alone or in combination with the virtual display unit 124 may operate to provide the digital apparatus on the remote computing device 26 such as the mobile phone 100 via the webpage.

In another embodiment, the webpage may include a special content 126 with or without the digital apparatus. For example, the special content 126 may be independent of the unique ID of the portable apparatus 10, such as the feedback terminal 70, thereby unrelated to the portable apparatus 10 or the digital replica 120 thereof. In another example, the special content 126 may be related to the user profile associated with the user key in the scanned QR code 72 (or the service request). As illustrated in FIG. 10, the webpage (or the associated website) may include the special content 126 such as a promotional offer displayed on the user interface of the mobile phone 100. Other examples of the special content 126 may include, but are not limited to, instructional content, educational content, and non-educational content. Examples of the instructional content may include, but are not limited to, user manual, food recipes, product assembly guide, online tutorials, safety procedures, and academic and workplace policies. Examples of the educational content may include, but are not limited to, textbook, documentary, online course material, and research papers. Examples of the non-educational content may include, but are not limited to, memes, jokes, music, songs, stories, movies, magazines, short videos, and animated content. In some examples, the non-educational content may also include promotional content such as advertisements, branding materials, discount offers, trial products or product demos, widgets, and coupons.

Further, in some examples, the special content 126 may include a single content, or one or more groups of the same or different types of contents. Examples of different content types may include, but are not limited to, textual, audio, images, video, monochromatic, colored, monolingual, and multilingual. In some examples, the special content 126 may a reference to additional content. For instance, the special content 126 may include URLs that may be clickable and configured to provide access to additional content other than that displayed on the webpage. Such additional content may include a supplementary content and/or a contrary content. The supplementary content may be related to the special content 126 displayed on the webpage. The contrary content may be unrelated to or different from the special content 126 displayed on the webpage at a set instant or for a set period.

In the displayed webpage, the controller 102 (or the server 110) may configure the digital replica 120 (and/or the special content 126) for display in a portrait orientation (shown in FIG. 10) or a landscape orientation (shown in FIG. 11) on the display screen 106 of the mobile phone 100. The controller 102 (or the server 110), in some examples, may adjust such orientations of the digital replica 120 (and/or the special content 126) depending on the corresponding orientations of the mobile phone 100, or the user interface thereof.

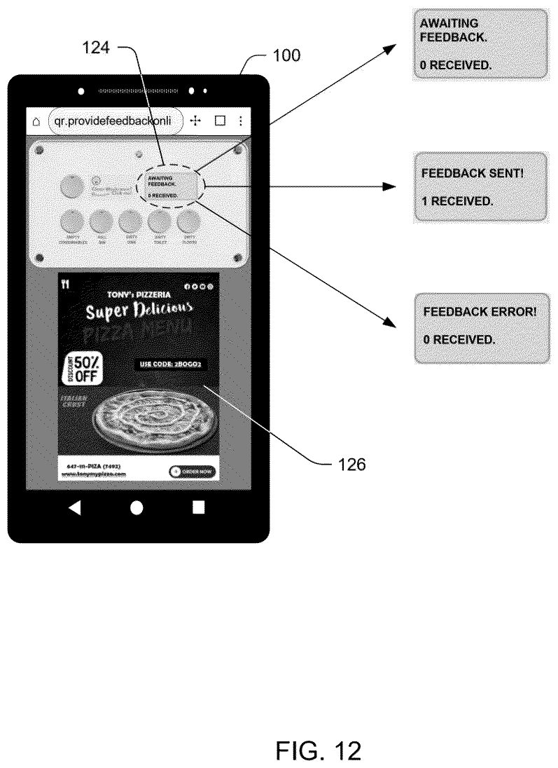

In one embodiment, the digital replica 120 may be configured to implement one or more functions of the feedback terminal 70 remotely. For example, the controller 102 may operate independently or in communication with a local software product (e.g., mobile App) to make the digital replica 120 and other displayed content interactive for a user. For example, the controller 102 (or the server 110) may implement the digital replica 120 in a feedback mode of the feedback terminal 70. In the feedback mode, as illustrated in FIG. 12, the controller 102 may display an input message, for example, “AWAITING FEEDBACK. 0 RECEIVED.”, indicating that the controller 102 (or the server 110) may be awaiting to receive an input, e.g., from a user. The user may click or touch one or more of the digital buttons 122 to provide a trigger signal (e.g., pulsed signal) for the controller 102 to register or receive an input (or feedback). Upon registering the input, the controller 102 may capture digital output data including (i) a data type (e.g., “issue” or “non-issue”) associated with the clicked digital button, (ii) a type of issue (e.g., “Empty Consumables”, “Full Bin”, “Satisfied”, etc.) associated with the clicked digital button, and (iii) the clock time at which the corresponding digital button may be clicked. The controller 102 may send the captured digital output data to the server 110 via the network 28 for insight analysis, reporting, sending notifications, and storage.

The controller 102 (or the server 110) may also display a message in the virtual display unit 124 of the digital replica 120 based on the digital buttons 122 being clicked or touched. For example, as illustrated in FIG. 12, when a single digital button, such as the digital button 122-1b may be clicked, the controller 102 may record digital output data including (i) the corresponding data type, i.e., “Issue”, (ii) the corresponding type of issue, i.e., “Full Bin” and (iii) the clock time at which the digital button 122-1b may be clicked. The controller 102 (or the local software product) may then send this digital output data via the network 28. Based on the digital output data being successfully received by the server 110, the controller 102 may cause to display a sent message, for example, “FEEDBACK SENT! 1 RECEIVED.”, on the virtual display unit 124 of the digital replica 120. In one embodiment, the controller 102 may tag the digital output data with the unique ID of the portable apparatus 10, such as the feedback terminal 70. The step of tagging may indicate to the server 110 that the associated digital output data may have been received from the portable apparatus 10 such as the feedback terminal 70, thereby associating the digitally-generated output data with the physical portable apparatus 10 such as the feedback terminal 70.

If, however, there may be an error or fault condition in sending the digital output data to the server 110 or no data receipt confirmation may be received from the server 110, the controller 102 (or the local software product) may display an error message, for example, “FEEDBACK ERROR! O RECEIVED.”, on the virtual display unit 124 of the digital replica 120. Examples of the fault condition may include, but are not limited to, network disconnection, low network signal strength, non-operational or dysfunctional mobile phone or the underlying user interface, and buffering or reloading of the webpage. Each of the sent message and the error message may be displayed for a set duration (e.g., approximately 2 seconds to approximately 10 seconds) by the controller 102 before switching back to displaying the input message on the virtual display unit 124. In some examples, the sent message and the error message may also be displayed on the display unit 16 of the feedback terminal 70 via the server 110.

In one embodiment, the server 110 may either reject any subsequent inputs or requests received from the IP address of the mobile phone 100 after the digital output data may be successfully received therefrom. For example, the server 110 may disable or make non-functional the webpage featuring the digital replica 120, or a web-link to the webpage, for the IP address of the mobile phone 100 after the digital output data may be successfully received by the server 110. This step of rejecting or disabling may prevent the server 110 from receiving redundant data or unsolicited inputs or requests from the mobile phone 100 after the inputs/feedback may have been already received therefrom, thereby saving system resources and data overload on the server 110. Further, the server 110 may disable the webpage, or a link thereto, associated with the QR code data that may have been invalidated. In some examples, the step of rejecting or disabling may be performed for a preset duration, e.g., ranging from approximately 1-hour to approximately 24 hours.

In some embodiments, the digital replica 120 may be implemented in the feedback mode on the mobile phone 100 independent of the one or more modes in the corresponding feedback terminal 70. For example, the digital replica 120 may be used by a first user to provide a first input (or feedback) while the corresponding feedback terminal 70 may be usable simultaneously by a second user to provide a second input (or feedback). Despite operating independent of the feedback terminal 70, the digital output data generated using the digital replica 120 may indicate or mimic the first input/feedback due to the tagging between the digital output data and the unique ID of the portable apparatus 10 such as the feedback terminal 70. Further, in some examples, the digital replica 120 and the corresponding feedback terminal 70 may operate in tandem with each other, such that the processor 12 in communication with the controller 102, either directly or via the server 110, may disable or delay the use of the digital apparatus including the digital replica 120 when the feedback terminal 70 may be in use, or vice versa.

In a further embodiment, the server 110 may send notifications to one or more remote computing devices upon receiving the digital output data. For example, the server 110 may send a notification to a remote computing device (e.g., mobile phone) linked to the user profile, which in turn may be associated with the unique ID of the feedback terminal 70 and/or the user key. The notification may indicate that an input or feedback may have been received with respect to (i) the feedback terminal 70 associated with the unique ID and (ii) a location associated with the unique ID and/or the corresponding feedback terminal 70. In some examples, the notification may include the digital output data received via the digital replica 120 of the feedback terminal 70. Other examples may comprise the notifications including data received from the feedback terminal 70. Examples of the notifications may include, but are not limited to, textual messages, audio, video, and images, or any combinations thereof. Similar to the digital apparatus including the digital replica 120, the physical portable apparatus 10 such as the feedback terminal 70 may be used by a user in one or more operational modes for providing an input or feedback.

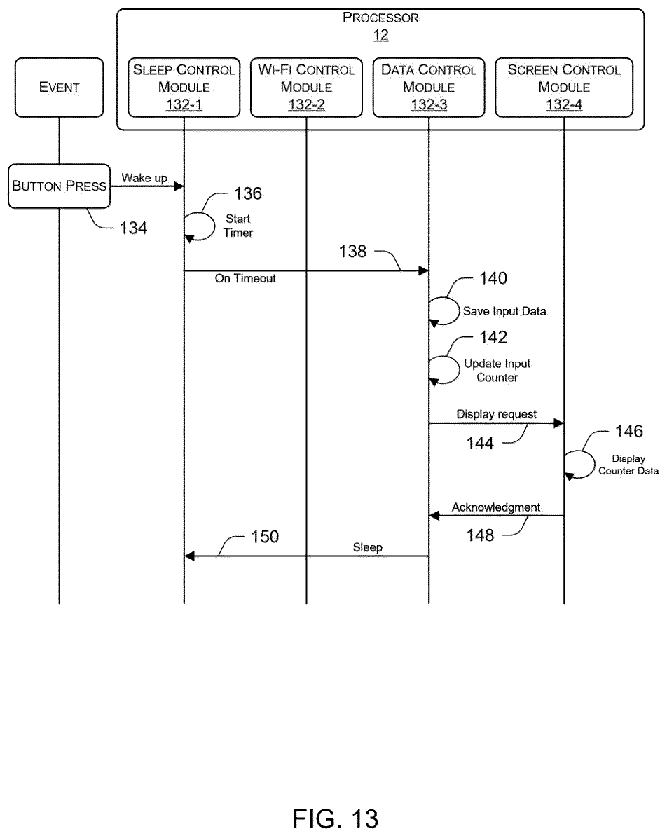

In one embodiment, the processor 12 may include one or more modules for implementing one or more operational modes on the portable apparatus 10 such as the feedback terminal 70. As illustrated in FIG. 13, the processor 12 may include a sleep control module 132-1, a Wi-Fi control module 132-2, a data control module 132-3, and a screen control module 132-4 (hereinafter collectively referred to as processing modules 132). Each of the processing modules 132 may be installed, integrated, or operatively associated with the processor 12 in communication with the memory 18. The processing modules 132 may operate to implement various operational modes in the feedback terminal 70. For example, the feedback terminal 70 may be implemented in a sleep mode, a feedback mode, a data update mode, a data upload mode, a maintenance mode, a Wi-Fi check mode, a validation mode, and a cleaning mode (collectively referred to as operational modes). In some examples, the processor 12 may be configured to perform functions of any of the processing modules 132, or vice versa. Other examples may include any of the processing modules 132 being combined or deleted, where the functionality of the deleted processing module(s) may be performed by the processor 12 or any of the other processing modules 132.

The processor 12 may implement exemplary methods to implement the one or more operational modes discussed in the present application with reference to FIGS. 13-19. The order in which each method is described is not intended to be construed as a limitation, and any number of the described method blocks or steps may be combined, deleted, or otherwise performed in any order to implement the method or an alternate method without departing from the concepts described in the present application. The exemplary methods may be described in the general context of computer-executable instructions, which may be stored on a computer readable medium, and installed or embedded in an appropriate device for execution. Further, the methods may be implemented in any suitable hardware, software, firmware, or combination thereof, that exists in the related art or that is later developed.

In one example, the processor 12 may be configured to initiate or terminate a group of operational modes simultaneously. In another example, the processor 12 may be configured to initiate or terminate a group of one or more operational modes mutually exclusive to each other, such that if one operational mode may be initiated or activated, the other operational modes in the group may be inhibited, delayed, or terminated. Other examples may include the processor 12 (or the processing modules 132) being configured to initiate or terminate a group of one or more operational modes in a set sequence or at regular intervals.

### Exemplary Sleep Mode

In one embodiment, the feedback terminal 70 may operate in the sleep mode (or sleep state) by default. In the sleep mode, the processor 12 may transition the feedback terminal 70 into a low power state to minimize battery consumption, thereby extending battery life. In the low power state, the processor 12 may (i) maintain the volatile memory 20 in a low power consumption state to retain data, (ii) power down the non-volatile memory 22 as well as driver circuits that assist in access thereto, (iii) turn off the network circuitry, such as Wi-Fi circuitry (not shown), to significantly inhibit or stop signal interaction with network devices, (iv) reduce processing activity, e.g., retaining power only to detect wake-up events, (v) power down non-essential peripherals (e.g., display unit 16, network adapter, etc.), (vi) put I/O interfaces 14 (e.g., ports) in low-power consumption state, e.g., retaining power only to detect wake-up events such as plugging of physical connectors, and (v) manage power controllers to monitor wake-up events and continue to run and maintain an internal clock source. The sleep mode may allow the feedback terminal 70 to conserve energy while still being able to resume full operation when needed. In some examples, instead of bringing the feedback terminal 70 to full operation upon a wake-up event, the processor 12 may be configured to selectively wake-up one or more hardware and software modules of the feedback terminal 70 only to the extent and in sequence as may be needed to implement the one or more operational modes.

### Exemplary Feedback Mode

In one embodiment, at step 134, the processor 12 may switch the feedback terminal 70 from the sleep mode to the feedback mode when one or more of the push-buttons 42 may be physically pressed. In the feedback mode, as illustrated in FIG. 13, a user may press one or more of the push-buttons 42 to provide an intended input or feedback regarding the perceived ambient conditions in or around a washroom. The push-buttons 42 may be pressed individually in any sequence. Each button press may provide a trigger signal (e.g., pulsed signal) and initiate a trigger event. The trigger signal may wake-up the sleep control module 132-1 from the sleep mode.

At step 136, in one embodiment, the sleep control module 132-1 may start a timer based on the pulsed signal during the feedback mode. The sleep control module 132-1 (or the processor 12) may configure the timer to run for a preset duration (or timer duration). The timer duration may range from approximately 1 second to approximately 4 seconds. In some examples, the sleep control module 132-1 (or the processor 12) may also activate a light source coupled to the push-button that may be pressed. The sleep control module 132-1 may activate the light source upon receiving the pulsed signal from the corresponding push-button. The light source may be activated for the timer duration and indicate to the user that the corresponding button press may have been received. In the present application, a timer may include hardware or a suitable combination of hardware and software.

At step 138, in one embodiment, when the timer stops, the sleep control module 132-1 (or the processor 12) may (i) turn-off the light source, and (ii) provide a trigger signal for the data control module 132-3. The timer (or the timer duration) may introduce a preset delay in providing the trigger signal based upon a button press. The preset delay may assist in (i) eliminating signal bouncing due to the mechanical nature of the push-buttons 42, (ii) provide time for the user to confirm that they intended to press the push-button, reducing accidental activations, and (iii) prevent unnecessary power consumption by ensuring that the processor 12 only activates various components when a button press may have been fully confirmed. After a push-button may be pressed, the sleep control module 132-1 (or the processor 12) may be configured to reject another valid input upon pressing the same push-button until the preset delay expires. In some examples, pressing the same push-button twice before the preset delay expires may undo an input (or a pulsed signal) previously received upon the prior press of that push-button. Other examples may include the sleep control module 132-1 (or the processor 12) being configured to reject or disregard a press of a push-button as a valid input if the push-button may have been pressed before the expiry of a preset delay associated with another push-button. Upon expiry of the preset delay, the sleep control module 132-1 (or the processor 12) may generate the trigger signal causing the data control module 132-3 (or the processor 12) to record button input data (or feedback data) associated with the push-button that may have been pressed.

At step 140, in one embodiment, the data control module 132-3 (or the processor 12) may save the button input data (or feedback data) in the memory 18. In one example, the button input data (or feedback data) may include (i) data associated with a pressed push-button providing the pulsed signal, (ii) a clock time at which the push-button may be pressed, and (ii) a data type associated with the pressed push-button. For example, when a user may press the push-button 42-1a, the data control module 132-3 (or the processor 12) may store (i) the clock time at which the issue button 42-1a may have been pressed, (ii) the corresponding data type, e.g., “Issue”, and (iii) the associated data, e.g., “Full Bin”. In one example, the data control module 132-3 (or the processor 12) may save the button input data (or feedback data) in the volatile memory 20 (e.g., cache memory). In another example, when a user may press the non-issue button 42-2, the data control module 132-3 may store (i) the clock time at which the non-issue button 42-2 may have been pressed, (ii) the corresponding data type, e.g., “non-issue”, and (iii) the associated data, e.g., “Satisfied”, in the volatile memory 20 (e.g., cache memory). Further, the data control module 132-3 (or the processor 12) may be configured to associate the feedback data with the unique ID of the feedback terminal 70, thereby indicating the source or origin of such feedback data.

At step 142, in one embodiment, the data control module 132-3 (or the processor 12) may update a value of an input counter of the feedback terminal 70. The input counter may assist in keeping track of the number of valid inputs (or the number of button presses). The data control module 132-3 (or the processor 12) may update the counter value based on the received valid input upon the button press. For example, if the input counter may be initially set to “0”, a user pressing a push-button, e.g., issue button 42-1a, may cause the data control module 132-3 (or the processor 12) to update the input counter to “1”. Similarly, if the input counter may be initially set to “3”, a user pressing a push-button, e.g., issue button 42-1a, may cause the data control module 132-3 (or the processor 12) to update the input counter to “4”. The data control module 132-3 (or the processor 12) may save the input counter value in the memory 18.

At step 144, in one embodiment, the data control module 132-3 (or the processor 12) may send a display request to the screen control module 132-4 to display the input counter value. The display request may operate to trigger the screen control module 132-4 (or the processor 12) to manage the display unit 16 for displaying the latest input counter value (or the saved counter value).

At step 146, in one embodiment, the screen control module 132-4 (or the processor 12) may fetch the input counter value from the memory 18 in response to the display request. The screen control module 132-4 (or the processor 12) may (i) drive the display unit 16 to display the input counter value and (ii) update or replace the already displayed input counter value with the latest counter value saved in the memory 18. For example, if the input counter value may be displayed as “0” on the display unit 16, a user pressing a push-button, e.g., issue button 42-1a, may cause the screen control module 132-4 (or the processor 12) to update the displayed input counter value to “1” on the display unit 16. Similarly, if the input counter value may be displayed as “3” on the display unit 16, a user pressing a push-button, e.g., issue button 42-1a, may cause the screen control module 132-4 to update the displayed counter value to “4” on the display unit 16. In some examples, the step of updating the input counter value may be performed by the display unit 16.

At step 148, in one embodiment, the screen control module 132-4 (or the processor 12) may send an acknowledgment back to the data control module 132-3 after the latest input counter value may have been displayed on the display unit 16. In some examples, the step of displaying the input counter value on the display unit 16 and sending the acknowledgment may be skipped, thereby keeping the screen control module 132-4 (and related hardware and software aspects) in the sleep mode to conserve battery power.

At step 150, in one embodiment, the data control module 132-3, upon receiving the acknowledgement, may send a sleep signal to the sleep control module 132-1. In some examples, the data control module 132-3 (or the processor 12) may send the sleep signal to the sleep control module 132-1 (or the processor 12) directly after the button input data (or feedback data) and the counter value may have been saved and/or updated in the memory 18. The sleep control module 132-1 (or the processor 12) may switch the processing modules 132 (and the feedback terminal 70) from the feedback mode back to the sleep mode upon receiving the sleep signal. The processing modules 132 (or the processor 12) may perform the above steps 134-150 each time a single push-button may be pressed to initiate the trigger event for the feedback mode.

### Exemplary Data Update Mode

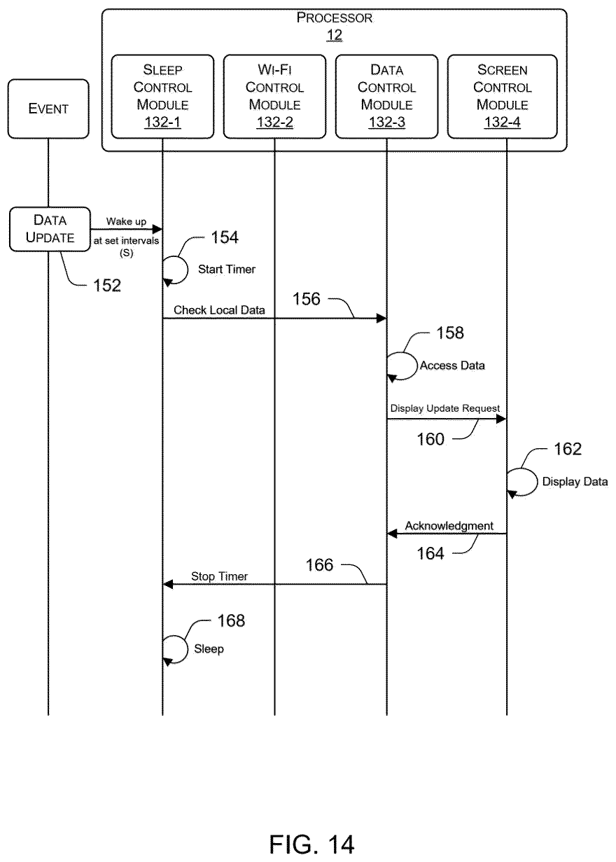

As illustrated in FIG. 14, in one embodiment, at step 152, the processor 12 may be configured to provide a trigger signal (e.g., pulsed signal) to initiate the data update mode in the portable apparatus 10 such as the feedback terminal 70. The trigger signal may initiate a trigger event to start the data update mode. In one example, the processor 12 may provide the trigger signal without any external stimulus, e.g., from the push-buttons 42 or the Wi-Fi circuitry. The processor 12 may be configured to provide the trigger signal at preset time intervals and/or for preset duration. For example, the processor 12 may generate the trigger signal (e.g., pulsed signal) at approximately 1-minute intervals (denoted as S). Other examples may include the preset intervals being greater than approximately 1 minute, for example, up to 5 minutes. The trigger signal may wake-up the sleep control module 132-1 (or the processor 12) from the sleep mode.

At step 154, in one embodiment, the sleep control module 132-1 (or the processor 12) may switch the portable apparatus 10 such as the feedback terminal 70 from the sleep mode to the data update mode based on the trigger signal. During the data update mode, the sleep control module 132-1 (or the processor 12) may be configured to start a timer for a preset duration (i.e., timer duration). In some examples, the timer duration may define a length of time (or duration) for which the data update mode may remain active. The timer duration may be less than approximately 2 seconds; however, some examples may include the timer duration being greater than approximately 2 seconds, for example, up to approximately 5 seconds during the data update mode.

At step 156, in one embodiment, the sleep control module 132-1 (or the processor 12) may send an active signal to the data control module 132-3 (or the processor 12) to check the latest data stored in the memory 18. The sleep control module 132-1 (or the processor 12) may send the active signal while the timer may still be active.

At step 158, in one embodiment, the data control module 132-3 (or the processor 12) may be configured to access and check data including (i) the last cleaning data, (ii) the remaining battery power, and (iii) generate or update the hash value for generating the dynamic, secure QR code 72. The data control module 132-3 (or the processor 12) may check the last cleaning data in the memory 18. In one example, the last cleaning data may correspond to the time elapsed since the clock time at which the last cleaning mode may be deactivated. Othe examples may include the last cleaning data corresponding to the time elapsed since the clock time at which the cleaning mode may be last deactivated. The data control module 132-3 (or the processor 12) may also check the battery status including (i) the remaining battery power and (ii) the remaining battery life of the feedback terminal 70. Further, the data control module 132-3 (or the processor 12) may execute the method of FIG. 9 to generate the dynamic, secure QR code 72. For example, the data control module 132-3 (or the processor 12) may check the current clock time of the feedback terminal 70 and update the hash value operating as the security feature if there may be a change in an hour of the day in the current clock time of the feedback terminal 70, as discussed above. The data control module 132-3 (or the processor 12) may collate the hash value depending of current clock time, the last cleaning data, and the battery status, and save the collated data in the memory 18.

At step 160, in one embodiment, the data control module 132-3 (or the processor 12) may send a display update request to the screen control module 132-4. In some examples, the display update request may include the collated data including (i) the last cleaning data, (ii) the battery status, and/or (iii) the generated or updated hash value. Other examples may include the display update request including a reference to the collated data saved in the memory 18 for display.

At step 162, in one embodiment, the screen control module 132-4 (or the processor 12) may be configured to receive the display request from the data control module 132-3 (or the processor 12). Based on the display update request, the screen control module 132-4 (or the processor 12) may access the collated data to prepare the corresponding information for display on the display unit 16. For example, if the last cleaning data may be displayed as “5 mins” on the display unit 16 and the cleaning mode may have been deactivated 2 minutes ago, the screen control module 132-4 (or the processor 12) may update the displayed last cleaning data to “2 mins” on the display unit 16. Similarly, if the last cleaning data may be displayed as “30 mins” on the display unit 16 and the time elapsed since the clock time at which the cleaning mode was last deactivated may be 10 minutes, the screen control module 132-4 may update the displayed last cleaning data to “10 mins” on the display unit 16.

Further, the screen control module 132-4 (or the processor 12) may generate and display the dynamic, secure QR code 72 based on the hash value in the collated data. The screen control module 132-4 (or the processor 12) may compare the hour of the day in the current clock time of the feedback terminal 70 with the hour of the day that may be stored in the memory 18. Based on the comparison, the screen control module 132-4 (or the processor 12) may generate a new QR code using the received hash value in the collated data if the hour of the day in the current clock time may be different from that stored in the memory 18. The screen control module 132-4 (or the processor 12) may also (i) invalidate the already displayed QR code, (ii) remove the already displayed QR code, and (iii) display the generated new QR code, as discussed above. However, in some examples, the step of invalidating may be performed by the data control module 132-3 (or the processor 12). Further, the screen control module 132-4 (or the processor 12) may be configured to update the battery status on the display unit 16. For example, the screen control module 132-4 (or the processor 12) may adjust the displayed battery icon (or select and display a new graphical element) to indicate the remaining battery power in the feedback terminal 70.

At step 164, in one embodiment, the screen control module 132-4 (or the processor 12) may send an acknowledgment back to the data control module 132-3 after updating the displayed information on the display unit 16. In some examples, the step of displaying the last cleaning data and the step of invalidating the existing QR code displayed on the display unit 16 may be skipped by the screen control module 132-4 (or the processor 12) at this step for performance in subsequent steps.

At step 166, in one embodiment, the data control module 132-3 (or the processor 12) may send a stop timer signal to the sleep control module 132-1 based on the acknowledgment. In some examples, the data control module 132-3 (or the processor 12) may perform the step of invalidating the existing QR code based on the received acknowledgment prior to sending the stop timer signal and after the new QR code may have been displayed on the display unit 16.

At step 168, in one embodiment, the sleep control module 132-1 (or the processor 12) may stop the timer based on the received stop timer signal. In some examples, the timer may be configured to automatically timeout and stop after the preset duration. Thus, the timer duration may assist in the timely powering down of the components to stop the data update mode and reduce battery consumption. If, however, the data control module 132-3 and screen control module 132-4 may be unable to complete their respective functions discussed above before the timer duration expires, the short preset intervals (e.g., approx. 1-minute intervals) for activating the data update mode may assist in updating the collated data and displaying data related thereto without the loss of perceived performance of the feedback terminal 70.

After the timer stops, the sleep control module 132-1 (or the processor 12) may switch the processing modules 132 (and the feedback terminal 70) from the data update mode back to the sleep mode. In one example, the processing modules 132 (or the processor 12) may trigger or perform the above steps 152-168 for implementing the data update mode concurrently with any other active operational mode. Thus, the data update mode may run at predefined intervals without hindering or delaying the initiation, operation, or termination of any other operational modes. Other examples may include the data update mode being stopped or delayed when another operational mode may be active.

### Exemplary Data Upload Mode

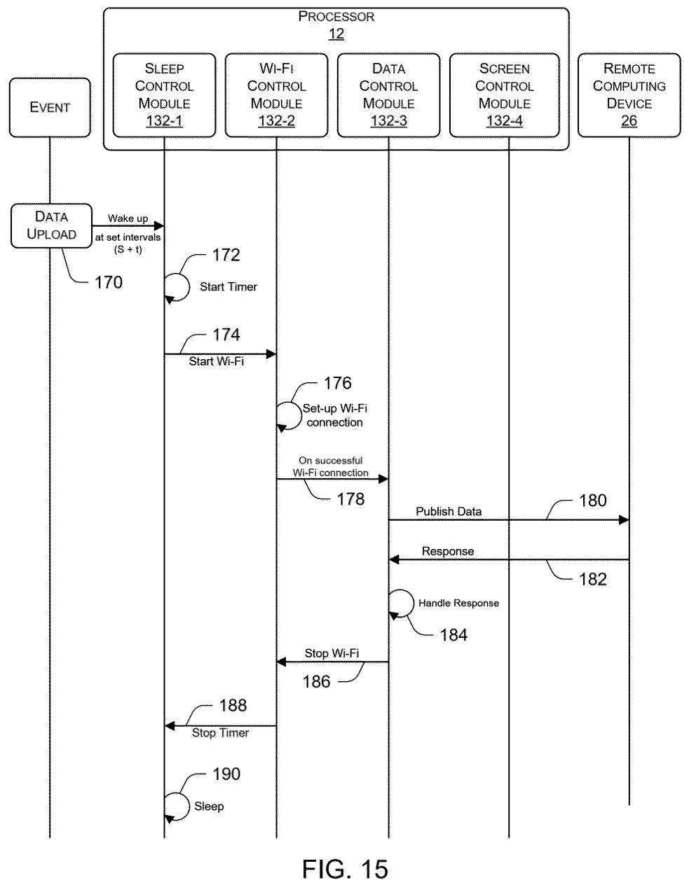

As illustrated in FIG. 15, in one embodiment, at step 170, the processor 12 may be configured to provide a trigger signal (e.g., pulsed signal) to initiate the data upload mode in the portable apparatus 10 such as the feedback terminal 70. The trigger signal may initiate a trigger event to start the data upload mode. Similar to the data update mode, in one example, the processor 12 may provide the trigger signal without any external stimulus, e.g., from the push-buttons 42 or the Wi-Fi circuitry for initiating the data upload mode. The processor 12 may be provide the trigger signal at preset time intervals and/or for preset duration. For example, the processor 12 may generate the trigger signal (e.g., pulsed signal) at approximately 5-minute intervals (denoted as S +t). Other examples may include the preset intervals being greater than approximately 5 minutes, for example, up to 30 minutes. The trigger signal may wake-up the sleep control module 132-1 (or the processor 12) from the sleep mode.

At step 172, in one embodiment, the sleep control module 132-1 (or the processor 12) may switch the portable apparatus 10 such as the feedback terminal 70 from the sleep mode to the data upload mode based on the trigger signal. During the data upload mode, the sleep control module 132-1 (or the processor 12) may be configured to start a timer for a preset duration (i.e., timer duration). In some examples, the timer duration may define a length of time (or duration) for which the data upload mode may remain active. The timer duration may range from approximately 2 seconds to approximately 60 seconds during the data upload mode.

At step 174, in one embodiment, the sleep control module 132-1 (or the processor 12) may send an active signal (e.g., “Start Wi-Fi™ signal”) to the data control module 132-3 (or the processor 12) to trigger a network circuitry via the Wi-Fi control module 132-2 (or the processor 12) for connecting to a nearby network such as a Wi-Fi™ network. The sleep control module 132-1 (or the processor 12) may send the active signal while the timer may still be active.

At step 176, in one embodiment, the Wi-Fi control module 132-2 (or the processor 12) may set-up a network connection, such as a Wi-Fi™ network connection. The Wi-Fi control module 132-2 (or the processor 12) may fetch the preset network data including a predetermined network ID (e.g., Wi-Fi™ SSID, etc.) and associated login credentials (e.g., username and password, login code, etc.) from the memory 18. Based on the preset network data, the Wi-Fi control module 132-2 (or the processor 12) may trigger the network circuitry, such as a Wi-Fi circuitry, to scan and connect with the Wi-Fi™ network corresponding to the predetermined network ID.

At step 178, in one embodiment, the Wi-Fi control module 132-2 (or the processor 12) may be configured to send a trigger signal to the data control module 132-3 (or the processor 12). The trigger signal may be sent after successfully connecting to the Wi-Fi™ network by the Wi-Fi control module 132-2 (or the processor 12).

At step 180, in one embodiment, the data control module 132-3 (or the processor 12) may establish a connection with a remote computing device, such as the server 110, for uploading the stored data. The data control module 132-3 (or the processor 12) may use the stored predefined network address for connecting to the server 110 associated therewith. The data control module 132-3 (or the processor 12) may establish the connection with the server 110 using the connected network, such as the Wi-Fi™ network. After the connection may be established, the data control module 132-3 (or the processor 12) may fetch and send data stored in the volatile memory 20 (e.g., cache memory) to the server 110.

At step 182, in one embodiment, the data control module 132-3 (or the processor 12) may await a data receipt response from the server 110 based on the sent data. The data control module 132-3 (or the processor 12) may await the response for a preset duration (i.e., waiting duration). In one example, the waiting duration may range from approximately 1 millisecond (ms) to approximately 4000 ms.

At step 184, in one embodiment, the data control module 132-3 (or the processor 12) may receive the data receipt response from the remote computing device 26 such as the server 110 before the waiting duration expires. Based on the data receipt response, the data control module 132-3 may determine whether or not the data sent from the memory 18 (e.g., cache data from the volatile memory 20) may have been successfully received by the remote computing device 26. If either the data receipt response indicates that the cache data is not received or the data receipt response may not be received at all, the data control module 132-3 (or the processor 12) may repeat step 180-184. In one example, the data control module 132-3 (or the processor 12) may repeat step 182 only for a set number of attempts/times, e.g., ranging up to 3 attempts. If the data receipt response indicates that the cache data may have been successfully received by the remote computing device 26, the data control module 132-3 (or the processor 12) may execute step 186.

At step 186, in one embodiment, the data control module 132-3 (processor 12) may send a stop Wi-Fi™ signal to the Wi-Fi control module 132-2 (or the processor 12) for terminating the network connection, e.g., the Wi-Fi™ network connection. The data control module 132-3 (processor 12) may send the stop Wi-Fi™ signal when (i) the data receipt response indicates that the remote computing device 26 such as the server 110 may have successfully received the sent data before expiration of the preset waiting duration, (ii) the waiting duration may have expired, or (iii) the data control module 132-3 (or the processor 12) may have repeated step 180 for the set number of attempts without receiving the data receipt confirmation in the response. Based on the stop Wi-Fi™ signal, the Wi-Fi control module 132-2 (or the processor 12) may (i) deactivate the network circuitry such as the Wi-Fi circuitry, (ii) disconnect from the network 28 such as the Wi-Fi™ network, and (iii) send a stop timer signal to the sleep control module 132-1 (or the processor 12).

At step 188, in one embodiment, the Wi-Fi control module 132-2 (or the processor 12) may send the stop timer signal to the sleep control module 132-1 (or the processor 12). Based on the stop timer signal, the sleep control module 132-1 (or the processor 12) may stop the timer. In some examples, during the data upload mode, the timer may be configured to automatically timeout and stop after the preset duration. Thus, the timer duration may assist in the timely powering down of the components to stop the data upload mode and reduce battery consumption. If, however, the Wi-Fi control module 132-2 or the data control module 132-3 may be unable to complete their respective functions discussed above before the timer duration expires, the processor 12 may try again after the preset interval.

At step 190, in one embodiment, after the timer stops, the sleep control module 132-1 (or the processor 12) may switch the processing modules 132 (and the feedback terminal 70) from the data upload mode back to the sleep mode. In one example, the processing modules 132 (or the processor 12) may trigger perform the above steps 170-190 for implementing the data upload mode concurrently with any other active operational mode. Thus, the data upload mode may run at predefined intervals without hindering or delaying the initiation, operation, or termination of any other operational modes. Other examples may include the data upload mode being stopped or delayed when another operational mode may be active. Since the data upload mode involves activation of the network circuitry, the step of switching ON the data upload mode less frequently, e.g., at set intervals or for shorter durations, may reduce the battery consumption. However, the frequency of activating the data upload mode may be carefully adjusted to align with the need for timely assessment of received inputs or feedback, ensuring that the notifications may be sent promptly to network devices linked to the user profile based on the received inputs (or feedback) for timely action.

### Exemplary Maintenance Mode

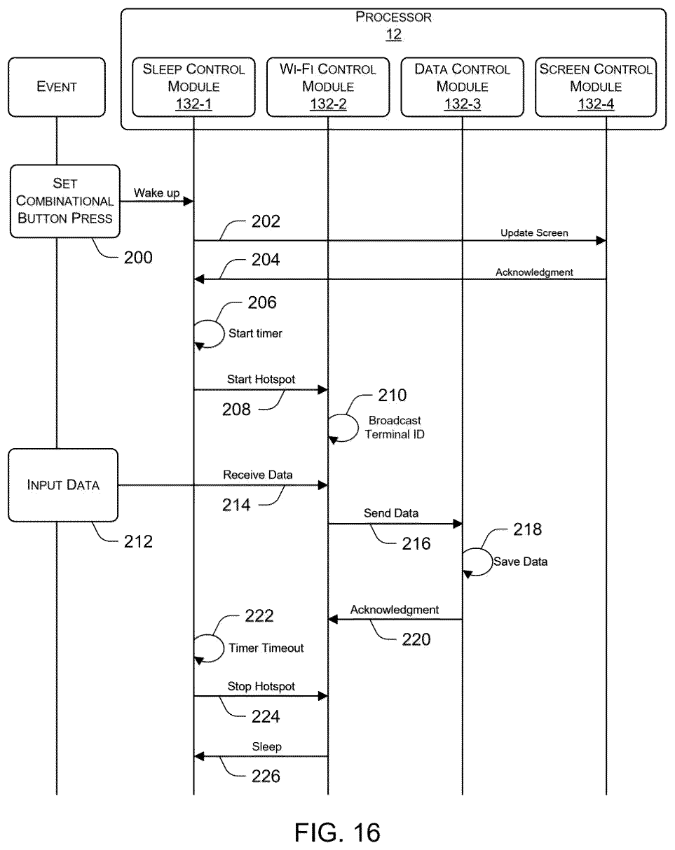

In one embodiment, the processor 12 may switch the feedback terminal 70 from the sleep mode to the maintenance mode based on a set combination of buttons being manipulated simultaneously. As illustrated in FIG. 16, in the maintenance mode, the processor 12 may enable a remote computing device such as a mobile device (not shown) to detect and/or establish a one-on-one connection with the feedback terminal 70. In some examples, the processor 12 may be adapted to receive a network configuration file from a remote computing device such as the mobile device in the maintenance mode.

At step 200, in one embodiment, a user may press-and-hold a set combination of push-buttons for a preset duration to generate a trigger signal (e.g., pulsed signal) that exceeds a predefined time threshold. The preset time threshold (or such preset duration) may range from approximately 50 ms to approximately 2000 ms. Based on the trigger signal, the processor 12 may initiate a trigger event. The trigger signal may wake-up the sleep control module 132-1 from the sleep mode.

At step 202, in one embodiment, the sleep control module 132-1 (or the processor 12) may send an update screen request to the screen control module 132-4 (or the processor 12) for indicating to the user that the maintenance mode may have started. For example, the screen control module 132-4 (or the processor 12) may display a message, e.g., “Maintenance Mode On”, on the display unit 16 to indicate that the maintenance mode has been activated. In another example, the screen control module 132-4 (or the processor 12) may trigger a light source to glow or blink, or play a sound or audio on a connected speaker, for a predetermined duration to indicate the initiation of the maintenance mode.

At step 204, in one embodiment, the screen control module 132-4 (or the processor 12) may send an acknowledgment back to the sleep control module 132-1 (or the processor 12) upon indicating the initiation of maintenance mode. In some examples, the step of displaying the message and sending back the acknowledgment may be skipped during the maintenance mode, thereby keeping the screen control module 132-4 (and related hardware and software aspects) in the sleep mode.

At step 206, in one embodiment, the sleep control module 132-1 (or the processor 12) may start a timer during the maintenance mode based on the acknowledgment. The sleep control module 132-1 (or the processor 12) may configure the timer to run for a preset duration (timer duration). In one example, the timer duration may range from approximately 2 seconds to approximately 20 seconds during the maintenance mode. In some examples, the timer duration may define a length of time for which the maintenance mode may remain active.

At step 208, in one embodiment, the sleep control module 132-1 (or the processor 12) may send a start hotspot request to the Wi-Fi control module 132-2. The sleep control module 132-1 (or the processor 12) may send the request while the timer may be active.

At step 210, in one embodiment, the Wi-Fi control module 132-2 (or the processor 12) may trigger a network circuitry such as the Wi-Fi circuitry based on the start hotspot request. The Wi-Fi circuitry (and the feedback terminal 70) may be operated as a hotspot by the Wi-Fi control module 132-2 (or the processor 12). As the hotspot, the Wi-Fi circuitry may operate to broadcast the unique ID (or terminal ID) of the feedback terminal 70. The terminal ID may allow a remote computing device to detect and/or connect to the feedback terminal 70. For example, at step 212, the terminal ID may be detected by a local software product (e.g., mobile App, system software, etc.) installed on the mobile device. The local software product may be configured to detect the terminal ID and establish a one-on-one communication channel with the processor 12 of the feedback terminal 70. The Wi-Fi control module 132-2 (or the processor 12) may be configured to receive input data from the mobile device over the established communication channel.

At step 214, in one embodiment, the remote computing device 26 such as the mobile device installed with the local software product may send the input data to the Wi-Fi control module 132-2 (or the processor 12). The input data may include, without limitation, a network configuration file, a system configuration file, a software product (e.g., firmware), or a software patch, or any combinations thereof. In one example, the network configuration file may include a network ID (e.g., SSID) of a set Wi-Fi™ network and related login credentials for setting-up or configuring that Wi-Fi™ network on the feedback terminal 70. The network configuration file (including the login credentials) may assist the Wi-Fi control module 132-2 (or the processor 12) in automatically connecting to the set Wi-Fi™ network whenever available in the future.

At step 216, in one embodiment, the Wi-Fi control module 132-2 (or the processor 12) may send the received input data to the data control module 132-3 (or the processor 12) for saving the input data in the memory 18.

At step 218, in one embodiment, the data control module 132-3 (or the processor 12) may save the received input data in the memory 18, such as the non-volatile memory 22.

At step 220, in one embodiment, the data control module 132-3 (or the processor 12) may send an acknowledgment to the Wi-Fi control module 132-2 (or the processor 12). Upon receiving the acknowledgement, the Wi-Fi control module 132-2 (or the processor 12) may await the timer to timeout.

At step 222, in one embodiment, the timer may stop after the preset duration (timer duration). The timer duration may assist in the timely powering down of the Wi-Fi control module 132-2, the data control module 132-3, and the screen control module 132-4, and related hardware, to stop the maintenance mode and reduce battery consumption. Based on the timer duration, the timer may trigger stopping of the maintenance mode even if the processing modules 132 may be unable to complete their respective functions.

At step 224, in one embodiment, the sleep control module 132-1 (or the processor 12) may send a stop hotspot request to the Wi-Fi control module 132-2 (or the processor 12) when the timer stops. Based on the stop hotspot request, the Wi-Fi control module 132-2 (or the processor 12) may power down the Wi-Fi circuitry to stop operating as the hotspot.

At step 226, in one embodiment, the Wi-Fi control module 132-2 (or the processor 12) may send a sleep signal to the sleep control module 132-1 (or the processor 12). The Wi-Fi control module 132-2 may send the sleep signal upon powering down the Wi-Fi circuitry. Based on the sleep signal, the sleep control module 132-1 (or the processor 12) may switch the processing modules 132 (and the feedback terminal 70) from the maintenance mode back to the sleep mode.

In some examples, any of the Wi-Fi control module 132-2, the data control module 132-3, and the screen control module 132-4 may directly send the sleep signal to the sleep control module 132-1 (or the processor 12) upon timer timeout. In some examples, the processor 12 (or the processing modules 132) may need at least steps 212-220 to complete before the timer expires or stops. If the feedback terminal 70 switches out of the maintenance mode prior to receiving the input data via the remote computing device 26, the user may again initiate the maintenance mode and restart from step 200. Other examples may include the processing modules 132 (or the processor 12) performing the above steps 200-226 to implement the maintenance mode mutually exclusive to the other operational modes. The processor 12 may deactivate all other operational modes while the maintenance mode may be active.

### Exemplary Wi-Fi Check Mode

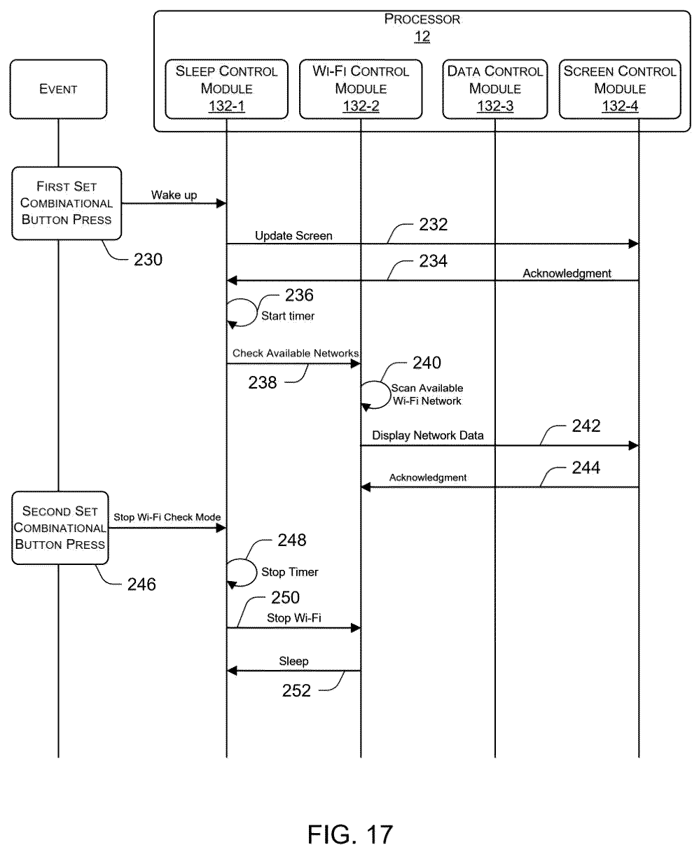

In one embodiment, the processor 12 may switch the feedback terminal 70 from the sleep mode to the Wi-Fi check mode based on a set combination of buttons being manipulated simultaneously. As illustrated in FIG. 17, in the Wi-Fi check mode, the processor 12 may scan and cause to display the available Wi-Fi™ networks and network data related thereto.

At step 230, in one embodiment, a user may press-and-hold a first set combination of push-buttons for a preset duration to generate a trigger signal (e.g., pulsed signal) that exceeds a predefined time threshold. The preset time threshold (or such preset duration) of the first set combination may range from approximately 50 ms to approximately 2000 ms. Based on the trigger signal, the processor 12 may initiate a trigger event. The trigger signal may wake-up the sleep control module 132-1 (or the processor 12) from the sleep mode.

At step 232, in one embodiment, the sleep control module 132-1 (or the processor 12) may send an update screen request to the screen control module 132-4 (or the processor 12) for indicating to the user that the Wi-Fi check mode may have started. In one example, the screen control module 132-4 (or the processor 12) may display a message, e.g., “Wi-Fi™ Check On”, on the display unit 16 to indicate that the Wi-Fi check mode has been activated. In another example, the screen control module 132-4 (or the processor 12) may trigger a light source to glow or blink, or play a sound or audio on a connected speaker, for a predetermined duration to indicate that the Wi-Fi check mode may have begun.

At step 234, in one embodiment, the screen control module 132-4 (or the processor 12) may send an acknowledgment back to the sleep control module 132-1 after indicating the initiation of the Wi-Fi check mode. In some examples, the step of displaying the message and sending back the acknowledgment may be skipped during the Wi-Fi check mode, thereby keeping the screen control module 132-4 (and related hardware and software processor 12 aspects) in the sleep mode to conserve battery power.

At step 236, in one embodiment, the sleep control module 132-1 (or the processor 12) may start a timer during the Wi-Fi check mode based on the acknowledgment. The sleep control module 132-1 may configure the timer to run for a preset duration. In one example, the timer duration may range from approximately 2 seconds to approximately 20 seconds during the Wi-Fi check mode. In some examples, the timer duration may define a length of time for which the Wi-Fi check mode may remain active.

At step 238, in one embodiment, the sleep control module 132-1 (or the processor 12) may send a check network request to the Wi-Fi control module 132-2 (or the processor 12). The sleep control module 132-1 (or the processor 12) may send the request while the timer may be active.

At step 240, in one embodiment, based on the check network request, the Wi-Fi control module 132-2 (or the processor 12) may trigger a network circuitry such as the Wi-Fi circuitry to scan for all available Wi-Fi™ networks. In one example, the Wi-Fi control module 132-2 (or the processor 12) may detect the network data associated with the available Wi-Fi™ networks. The network data may include one or more Wi-Fi™ networks and signal strengths associated therewith. In some instances, the network data may further include a reference signal strength. In some examples, the Wi-Fi control module 132-2 may save the network data in the memory 18, such as the volatile memory 20 (e.g., cache memory).

At step 242, in one embodiment, the Wi-Fi control module 132-2 (or the processor 12) may send a display request to the screen control module 132-4 (or the processor 12) for displaying the network data. The screen control module 132-4 (or the processor 12) may receive and display the scanned network data on the display unit 16 based on the display request.

At step 244, in one embodiment, after the network data may be displayed, the screen control module 132-4 (or the processor 12) may send an acknowledgment back to the Wi-Fi control module 132-2 (or the processor 12). Based on the acknowledgement, the Wi-Fi control module 132-2 (or the processor 12) may await receiving a trigger signal to stop the Wi-Fi check mode or for the timer to timeout.

At step 246, in one embodiment, a user may press-and-hold a second set combination of push-buttons for a preset duration to generate a trigger signal (e.g., pulsed signal) that exceeds a predefined time threshold. The preset time threshold (or such preset duration) of the second set combination may range from approximately 50 ms to approximately 2000 ms. The trigger signal may include a “Stop Wi-Fi check mode” request. The trigger signal may cause the sleep control module 132-1 (or the processor 12) to stop the timer. In one example, the second set combination of push-buttons may be same as the first set combination of push-buttons used to initiate the Wi-Fi check mode; however, some examples may include the second set combination of push-buttons being different from the first set combination of push-buttons.

At step 248, in one embodiment, the sleep control module 132-1 (or the processor 12) may stop the timer based on the stop Wi-Fi check mode request. In some examples, the timer may automatically expire and stop after the preset duration, regardless of whether or not the second set combination of push-buttons may be pressed or the stop Wi-Fi check mode request may have been received by the sleep control module 132-1 (or the processor 12).

At step 250, in one embodiment, the sleep control module 132-1 (or the processor 12) may send a stop Wi-Fi™ request to the Wi-Fi control module 132-2 when the timer stops. Based on the stop Wi-Fi™ request, the Wi-Fi control module 132-2 (or the processor 12) may power down the Wi-Fi circuitry and stop the network 28 scan.

At step 252, in one embodiment, the Wi-Fi control module 132-2 (or the processor 12) may send a sleep signal to the sleep control module 132-1 (or the processor 12) after the Wi-Fi circuitry may be turned-off. The sleep control module 132-1 (or the processor 12) may switch the processing modules 132 (and the feedback terminal 70) from the Wi-Fi check mode back to the sleep mode upon receiving the sleep signal. In some examples, any of the Wi-Fi control module 132-2 and the screen control module 132-4 may directly send the sleep signal to the sleep control module 132-1 (or the processor 12) upon the timer timeout. In some examples, the processor 12 (or the processing modules 132) may need at least steps 238-244 to complete before the timer stops or the timer duration expires. In some examples, the processing modules 132 (or the processor 12) may perform the above steps 230-252 to implement the Wi-Fi check mode mutually exclusive to the other operational modes. The processor 12 may deactivate all other operational modes while the Wi-Fi check mode may be active.

### Exemplary Validation Mode

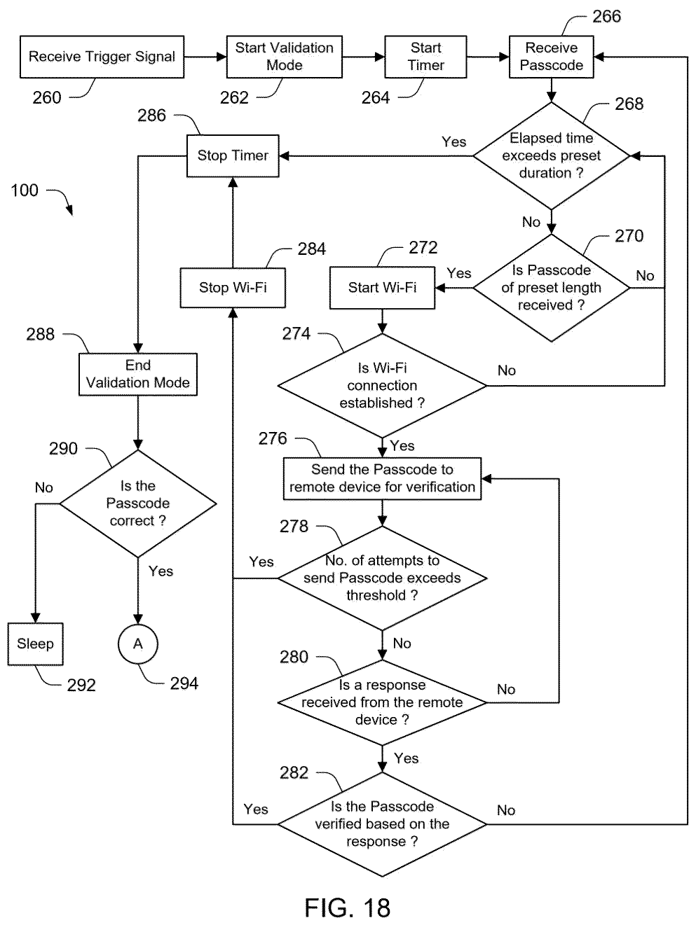

In one embodiment, the processor 12 may switch the feedback terminal 70 from the sleep mode to the validation mode. As illustrated in FIG. 18, in the validation mode, the processor 12 may verify whether or not a user may be authorized to access the cleaning mode on the feedback terminal 70.

At step 260, the processor 12 may receive a trigger signal based on a set combination of button press for a set duration. In one embodiment, a user may press-and-hold a set combination of push-buttons for a preset duration to generate a trigger signal (e.g., pulsed signal) that exceeds a predefined time threshold. The preset time threshold (or such preset duration) may range from approximately 50 ms to approximately 2000 ms. In some examples, the push-buttons may be automated and driven using the processor 12 to provide the trigger signal. Based on the trigger signal, the processor 12 may initiate a trigger event. The trigger signal may wake-up the processor 12 from the sleep mode.

At step 262, a validation mode is activated. In one embodiment, the processor 12 may be configured to initiate the validation mode in response to the trigger signal generated based on the set combination of push-buttons pressed by the user. Such set combination of push-buttons associated with the initiation of the validation mode may be stored in the memory 18 (such as the non-volatile memory 22, in one example) for access and reference by the processor 12. The validation mode may assist in authenticating the user for initiation of the cleaning mode. The processor 12 may initiate the cleaning mode based on the user being authenticated, discussed below in greater detail. In the validation mode, the processor 12 may operate in communication with the screen control module 132-4 to provide an indication, such as those mentioned above, to inform the user regarding the validation mode being initiated. The processor 12 may send the indication to a component of the feedback terminal 70 or a remote computing device such as those mentioned above. For example, the processor 12 may send a message, e.g., “VALIDATION MODE INITIATED” for display on the display unit 16 of the feedback terminal 70.

At step 264, a timer is started. In one embodiment, the processor 12 may initiate a timer during the validation mode. The processor 12 may configure the timer to run for a preset duration (or timer duration), for example, ranging from approximately 5 seconds to approximately 10 seconds. In some examples, the timer may govern a duration for which the validation mode may remain active. For instance, the processor 12 may be configured to end the validation mode upon expiry of this timer duration.

At step 266, a passcode is received. In one embodiment, the processor 12 may request a user to enter a passcode for verification. The passcode may assist in verifying whether or not the user providing the passcode may be authorized to access the cleaning mode. The processor 12 may be configured to receive the entered passcode of a preset length, such as four characters. The preset length (e.g., number of characters) of the expected passcode may be prestored in the memory 18, such as the non-volatile memory 22.

In one example, the processor 12 may cause to display a message, e.g., “ENTER PASSCODE”, on the display unit 16 to request the user for a passcode. The user may press the one or more issue buttons and/or the non-issue button to enter the passcode of the preset length. For instance, the push-buttons 42-1a, 42-1b, 42-1d, and 42-2 may be pressed to enter a four-character passcode. In another instance, a combination of different issue buttons may be used to enter the passcode of the preset length. For instance, the push-buttons 42-1a, 42-1b, 42-1d, and 42-1e may be pressed to enter the four-character passcode.

In some examples, each of the issue buttons 42-1 may indicate a number when pressed during the validation mode. For instance, when the push-buttons 42-1a, 42-1b, 42-1d, and 42-1e may be pressed, the processor 12 may register the numbers “1”, “2”, “4”, and “5” respectively for the passcode, during the validation mode. Other examples may include each press of the one or more the push-buttons 42 being displayed on the display unit 16 by the processor 12 to indicate that the corresponding characters (or numbers) being registered toward the passcode. In a further example, the processor 12 may be configured to register a button press as a valid input toward the passcode after a set delay. In one example, the set delay may be stored in the memory 18 (e.g., non-volatile memory 22) and range from approximately 500 ms to approximately 2000 ms. In some examples, if the same push-button may be pressed twice before the associated set delay expires, the processor 12 may undo an input (or a pulsed signal) previously received upon the prior press of that push-button. Other examples may include the processor 12 being configured to reject or disregard a press of a push-button as a valid input if the push-button may have been pressed before the expiry of a preset delay associated with another push-button.

At step 268, elapsed time threshold is determined. In one embodiment, the processor 12 may be configured with a preset duration to receive the passcode. The preset duration may be associated with the timer started in step 264. The processor 12 may check whether the preset duration has expired or a time elapsed since the start of the timer may have reached a predefined threshold. If such elapsed time threshold may have been reached (i.e., the preset duration associated with the timer may have expired), the processor 12 may execute step 286. On the other hand, the processor 12 may execute step 270 if the elapsed time threshold may not have been reached, i.e., the preset duration associated with the timer may be still active.

At step 270, a receipt of the passcode is determined. In one embodiment, the processor 12 may be configured to determine whether or not the preset length of passcode may have been received. If the passcode of the preset length may have been received, the processor 12 may execute step 272. However, the processor 12 may execute step 268 if the received passcode may have a length less than the preset length. The processor 12 may allow the user to continue entering the passcode, or edit a part thereof, until either the preset duration associated with the timer of step 268 expires or the passcode may be successfully verified.

At step 272, Wi-Fi circuitry is started. In one embodiment, the processor 12 may operate to activate a network circuitry such as the Wi-Fi circuitry and scan the available Wi-Fi™ networks. In one example, the processor 12 (or the Wi-Fi control module 132-2) may attempt to establish a connection with a predefined Wi-Fi™ network based on the predefined network data (e.g., set Wi-Fi™ network and login credentials thereof) stored in the memory 18.

At step 274, a valid Wi-Fi™ connection is checked. In one embodiment, the processor 12 may determine whether or not the Wi-Fi circuitry (and the feedback terminal 70) may have connected to a predefined Wi-Fi™ network. If the Wi-Fi circuitry may be successfully connected to the predefined Wi-Fi™ network, the processor 12 may execute step 276. On the other hand, the processor 12 may execute step 268 if the Wi-Fi circuitry (and the processor 12) may yet to be connected to an available Wi-Fi™ network.

At step 276, the received passcode is sent to a remote computing device. In one embodiment, the processor 12 may attempt to connect to a predefined remote computing device such as the server 110 over the network 28 such as the Wi-Fi™ network. The remote computing device may be predefined based on the network address associated therewith stored in the memory 18 (e.g., the non-volatile memory 22). Once the connection is established, the processor 12 may send the passcode received from the user (hereinafter referred to as the user passcode) to the remote computing device 26 such as the server 110 for verification. After the user passcode may be sent, the processor 12 may await the receipt of a passcode verification file (or a passcode confirmation) from the remote computing device 26 such as the server 110.

At step 278, a number of attempts to send the passcode is determined. In one embodiment, the processor 12 may be configured to resend the user passcode to the remote computing device 26 such as the server 110 if a response therefrom may not be received within a set duration. The response may include the passcode verification file or a bit value indicating a verification status of the sent user passcode. The number of attempts to send the user passcode may be preset for the processor 12 and stored in the memory 18 (e.g., the non-volatile memory 22). The preset number of attempts may range up to 5 (attempt threshold) within a set duration associated therewith. In some examples, the processor 12 may be configured to make any number of attempts within the set duration associated therewith. The set duration associated with a wait time for receiving the server response may range from approximately 10 ms to approximately 4000 ms. In some examples, a set duration associated with the attempt threshold or the number of attempts may be same as that associated with the wait time. If the number of attempts to send the passcode may exceed the attempt threshold (or, in some examples, the set duration may have expired), the processor 12 may execute step 284. On the other hand, the processor 12 may execute step 280 if the maximum number of attempts may be less than or equal to the attempt threshold or the set duration (i.e., wait time) may not have expired.

At step 280, the receipt of a passcode verification file is determined. In one embodiment, the processor 12 may be configured to receive a response from the remote computing device 26 such as the server 110 based on the user passcode sent thereto. In some examples, the processor 12 may check for the passcode verification file (or a passcode confirmation) with the response received from the server 110. The passcode verification file may indicate whether the user passcode matches the expected passcode for providing an access to the cleaning mode of the feedback terminal 70. In some examples, the passcode verification file may include the passcode confirmation. Other examples may include the passcode verification file including the expected passcode. If the passcode verification file may be received, the processor 12 may execute step 282. On the other hand, the processor 12 may execute step 276 if the passcode verification file may not be received from the server 110 before expiry of the wait time.

At step 282, passcode verification is performed. In one embodiment, the processor 12 may be configured to verify the user passcode using the passcode verification file. In one example, the passcode verification file may include the expected passcode. The processor 12 may compare the expected passcode with that received from the user. Based on the comparison, the processor 12 may determine the user passcode to be correct upon a match with the expected passcode. The processor 12 may determine the user passcode as incorrect when different from the expected passcode. In another example, the passcode verification file (or a server response signal) may include a data bit value indicating whether or not the user passcode may be correct. For instance, the passcode verification file (or the server response signal) may include a data bit having a set value, where the set value being “1” may indicate that the user passcode may be correct and the set value being “0” may indicate that the user passcode may be incorrect. If the user passcode may be verified, e.g., to be correct, the processor 12 may execute step 284. On the other hand, the processor 12 may execute step 266 if the user passcode may be verified, e.g., to be incorrect.

At step 284, Wi-Fi™ connection is stopped. In one embodiment, the processor 12 may operate to power down the Wi-Fi circuitry and disconnect the feedback terminal 70 from the network 28 such as the Wi-Fi™ network based on (1) the user passcode being verified to be correct, (2) the number of attempts to send the user passcode to the remote computing device 26 such as the server 110 for verification exceeding the predefined attempt threshold, or (3) an expiry of the set duration associated with at least one of the number of attempts, the attempt threshold, and the wait time for receiving the server response. The processor 12 may power down the Wi-Fi circuitry. In some examples, the processor 12 may be switched back into the sleep mode until the next step.

At step 286, the timer is stopped. In one embodiment, the processor 12 may stop the timer in response to the Wi-Fi circuitry being powered down or switched to sleep mode. In some examples, the timer may stop automatically upon expiry of a preset timer duration associated therewith.

At step 288, the validation mode is terminated. In one embodiment, the processor 12 may terminate the validation mode based on the timer expiring or being stopped. Upon termination, the processor 12 may operate to provide an indication, such as those mentioned above, regarding the termination of the validation mode. For example, the processor 12 may cause to display a message, e.g., “VALIDATION MODE ENDED” on the display unit 16. In another example, the processor 12 may cause the display unit 16 to display the time elapsed since the last cleaning time and/or the dynamic QR code, as discussed above, to indicate the termination of the validation mode.

At step 290, the received passcode is checked for validity. In one embodiment, the processor 12 may determine whether the user passcode may be successfully verified as correct based on the passcode verification file. If the user passcode may be determined to be incorrect based on the passcode verification file, or when the passcode verification file may be never received from the predefined remote computing device such as the server 110, the processor 12 may execute step 292. On the other hand, the processor 12 may execute step 294 if the user passcode may be determined to be correct. The user passcode being determined to be correct may indicate that the user, who may have entered the passcode may be authorized to access the cleaning mode of the feedback terminal 70.

At step 292, the sleep mode is activated. In one embodiment, the processor 12 may be configured to initiate the sleep mode if the user passcode may be verified to be incorrect. On the other hand, the processor 12 may initiate the feedback mode in response to the user passcode determined to be invalid based on the passcode verification file or an unavailability thereof.

At step 294, the cleaning mode may be initiated in associated with the validation mode. In one embodiment, the processor 12 may initiate the cleaning mode upon authenticating the user in the validation mode. However, in some examples, the cleaning mode may be operable independent of the validation mode, e.g., when the processor 12 (or the Wi-Fi control module 132-2) may be unable to connect to the predefined remote computing device such as the server 110 over the network 28.

### Exemplary Cleaning Mode

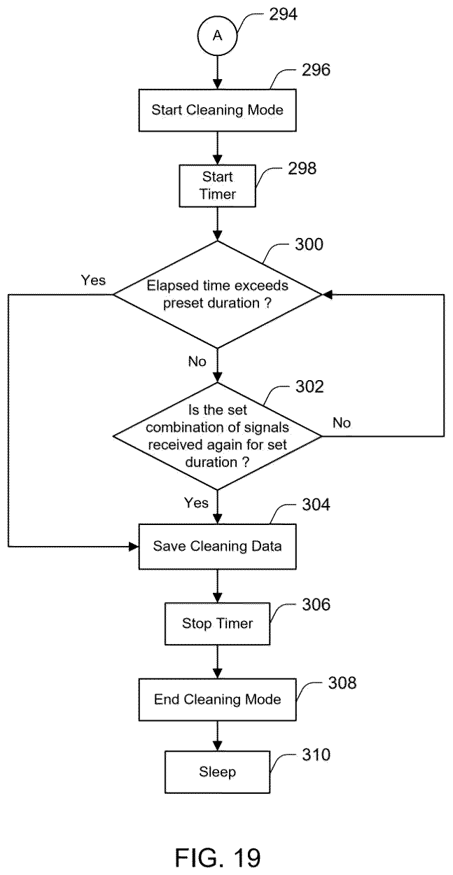

As illustrated in FIG. 19, the processor 12 may initiate the cleaning mode based on the user passcode being successfully verified to be correct during the validation mode. In the cleaning mode, the processor 12 may record a start clock time, an end clock time, and a duration therebetween for which the cleaning mode may be activated. The cleaning mode may indicate a local activity (e.g., cleaning activity) being performed in an area, such as a washroom, where the feedback terminal 70 may be deployed.

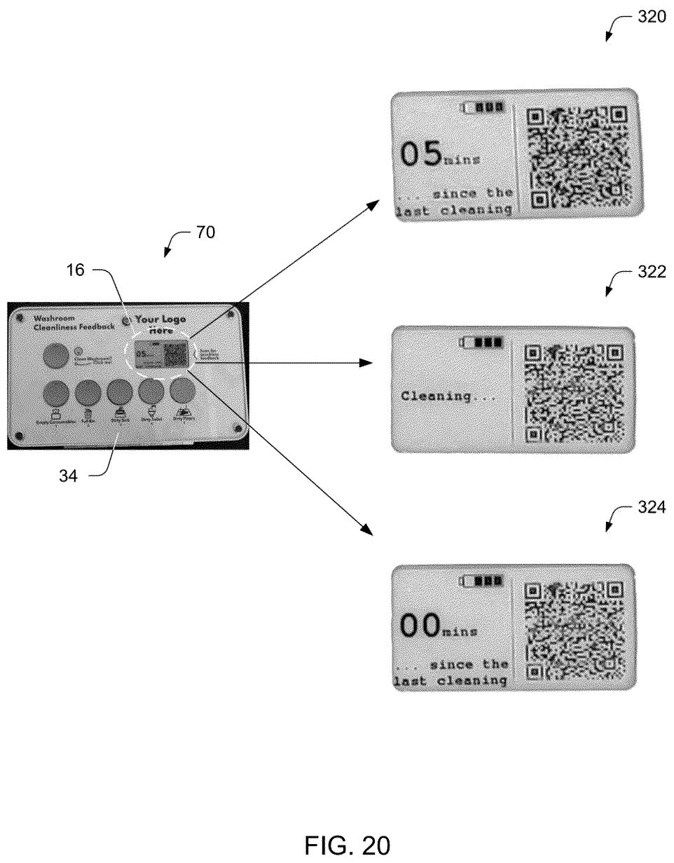

At step 296, the cleaning mode is started. In one embodiment, the processor 12 may initiate the cleaning mode on the feedback terminal 70. The processor 12 may save the start clock time of the cleaning mode in the memory 18 (e.g., the volatile memory 20 such as cache memory). The processor 12 may operate to provide an indication, such as those mentioned above, regarding the cleaning mode being activated. For example, as illustrated in FIG. 20, if the last cleaning data may be displayed as “05 mins . . . since the last cleaning” (shown in a first user interface 320) on the display unit 16, the processor 12 may cause to display a message, e.g., “Cleaning . . . ” (shown in a second user interface 322) on the display unit 16 to indicate activation of the cleaning mode.

At step 298, a timer is started. In one embodiment, the processor 12 may start a timer for a preset duration (or timer duration) during the cleaning mode. In some examples, the timer duration may define a length of time (or duration) for which the cleaning mode may remain active. The timer duration may range from approximately 5 minutes to approximately 30 minutes. The user may perform a local activity (e.g., cleaning or maintenance activity) related to the indoor area (e.g., washroom) where the feedback terminal 70 may be deployed.

At step 300, the elapsed time threshold is determined. In one embodiment, the processor 12 may be configured to run the cleaning mode for a preset duration associated with the timer started in step 298. The processor 12 may check whether or not the preset duration (or timer duration) may have expired or a time elapsed since the start clock time may have reached a preset elapsed time threshold. If such elapsed time threshold may have been reached (i.e., the timer duration may have expired), the processor 12 may execute step 304. On the other hand, the processor 12 may execute step 302, if the elapsed time threshold may not yet be reached, i.e., the timer duration may still be active or ongoing.

At step 302, a set combination of button press is checked. In one embodiment, the processor 12 may await a trigger signal based on a set combination of push-buttons being pressed. For example, a user may press-and-hold a set combination of push-buttons for a preset duration to generate the trigger signal (e.g., pulsed signal) that exceeds a predefined time threshold. The preset time threshold (or such preset duration) of the set combination may range from approximately 50 ms to approximately 2000 ms. The processor 12 may check whether the set combination of push-buttons pressed together and the preset duration associated therewith may be the same as those used for activating the validation mode. If the same set combination of push-buttons may be pressed together for the same set duration based on the check, the processor 12 may execute step 304. On the other hand, the processor 12 may execute step 300 if the set combination of push-buttons pressed may be different from those used for activating the validation mode.

At step 304, cleaning data is saved. In one embodiment, the processor 12 may save the cleaning data in the memory 18 when the set combination of push-buttons pressed together may be same as those used for activating the validation mode. The cleaning data may include the end clock time at which the set combination of push-buttons may be pressed together. In one example, the processor 12 may save the cleaning data in both the volatile memory 20 and the non-volatile memory 22. In some examples, the processor 12 may save the cleaning data in the memory 18 upon expiry of the timer duration.

At step 306, the timer is stopped. In one embodiment, the processor 12 may stop the timer after the cleaning data may be saved in the memory 18. In some examples, the timer may automatically timeout and stop upon expiry of the timer duration associated therewith. The timer duration may range from approximately 5 minutes to approximately 30 minutes. When the timer may timeout and stop after the timer duration, the processor 12 may save the end clock time at which the timer may timeout or stop in the memory 18.

At step 308, the cleaning mode is terminated. In one embodiment, the processor 12 may end the cleaning mode based on the timer being stopped or upon expiry of the timer duration. At step 310, in one embodiment, the processor 12 may switch the feedback terminal 70 from the cleaning mode to the sleep mode when the timer stops. In some examples, the processor 12 may switch the feedback terminal 70 to (or initiate) the feedback mode based on the cleaning mode being terminated upon expiry of the timer duration. Further, the processor 12 may be configured to update a user interface of the display unit 16 to indicate the termination of the cleaning mode. For example, the processor 12 may update the last cleaning data and display “00 mins . . . since the last cleaning” (shown in a third user interface 324) on the display unit 16 upon deactivation or termination of the cleaning mode.

### Exemplary Operation

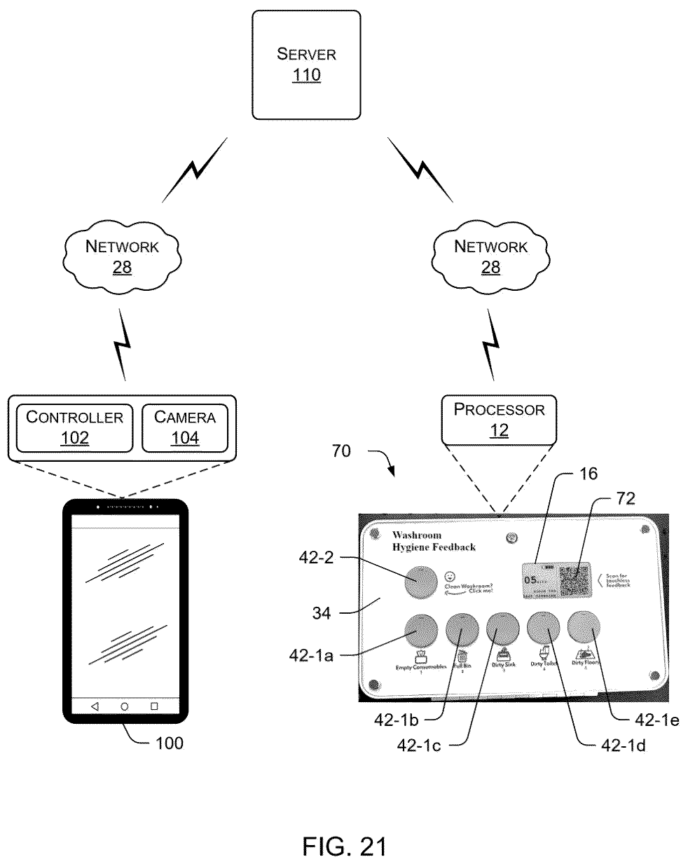

In one embodiment, an attendant may set-up and physically deploy the portable apparatus 10 such as the feedback terminal 70 for receiving user feedback on ambient hygiene in an indoor location such as a washroom. The feedback terminal 70 may include a software product installed or operatively communicating with the processor 12. The software product may be configured to implement and manage and various operational modes and data on the feedback terminal 70 and assist in communicating with network devices over a network such as the network 28. In one example, the software product may (i) maintain the feedback terminal 70 in sleep mode by default and (ii) access, store, and manage the unique ID associated with the feedback terminal 70 in the memory 18. As illustrated in FIG. 21, the feedback terminal 70 may be configured to operate in communication with the remote computing devices such as the server 110 based on various operational modes. The feedback terminal 70 may facilitate receiving feedback regarding washroom hygiene from users and allow for responsive feedback management. The attendant may deploy the feedback terminal 70 at a suitable location proximate a washroom and set it up for automated network connection and communication. For example, the attendant may configure, deploy, engage, and responsively manage the user feedback using the feedback terminal 70. In some examples, the attendant may include a user.

### Exemplary Configuration

During operation, in one embodiment, the attendant may configure the portable apparatus 10 such as the feedback terminal 70 for deployment proximate an indoor location such as washroom. For example, the attendant may press-and-hold a set combination of push-buttons (namely, combination C1) on the feedback terminal 70. When the set combination C1 of push-buttons may be pressed together for a preset duration, the processor 12 may activate the maintenance mode on the feedback terminal 70. In the maintenance mode, the processor 12 may provide an indication to confirm the initiation of the maintenance mode and convert the feedback terminal 70 into a hotspot. For example, the processor 12 may display a message, e.g., “MAINTENANCE MODE ON . . . ” on the display unit 16 of the feedback terminal 70. Upon providing the indication, the processor 12 may activate the network circuitry such as the Wi-Fi circuitry and broadcast the unique ID (or terminal ID) of the feedback terminal 70. The terminal ID may allow a network device, e.g., a mobile device, to detect and connect with the feedback terminal 70. Upon connection, the network device may be used to provide input data to set-up the feedback terminal 70 for operation. The input data may include, without limitation, a network configuration file, a system configuration file, a software product (e.g., firmware), or a software patch, or any combinations thereof. In one example, the feedback terminal 70 may receive the network configuration file including an SSID of a Wi-Fi™ network in the vicinity and the login credentials associated therewith. The network configuration file may be saved in the memory 18 of the feedback terminal 70 by the processor 12 to automatically connect the feedback terminal 70 with such Wi-Fi™ network thereafter. The maintenance mode may be configured to timeout and stop after a preset duration by the processor 12 for turning off the network circuitry and return the feedback terminal 70 to the sleep mode. Unlike the traditional solutions requiring such mobile device to permanently remain linked or connected to such feedback terminal 70 for operation, the maintenance mode allows for a temporary, one-time connection with the feedback terminal 70 for the initial set-up, thereby reducing battery usage, wear and tear, as well as operational costs.

### Exemplary Deployment

In one embodiment, the attendant may determine a suitable specific location proximate the washroom for deploying the portable apparatus 10 such as the feedback terminal 70. The attendant may use the Wi-Fi check mode for finding such suitable specific location for deploying the feedback terminal 70. For example, the attendant may press-and-hold a set combination of push-buttons (namely, combination C2) on the feedback terminal 70. When the set combination C2 of push-buttons may be pressed together for a preset duration, the processor 12 may activate the Wi-Fi check mode on the feedback terminal 70. In the Wi-Fi check mode, the processor 12 may provide an indication to confirm the initiation of the Wi-Fi check mode and scan for available networks in the vicinity. For example, the processor 12 may display a message, e.g., “Wi-Fi CHECK MODE ON . . . ” on the display unit 16 of the feedback terminal 70. Upon providing the indication, the processor 12 may activate the network circuitry such as the Wi-Fi circuitry and scan for the available networks, such as Wi-Fi™ networks, in the vicinity of the unique ID (or terminal ID) of the feedback terminal 70. Based on the scan, the processor 12 may display network data on the display unit 16. The network data may include SSIDs of various available Wi-Fi™ networks and the corresponding signal strengths in the vicinity of the feedback terminal 70. In some instances, the network data may further include a reference signal strength.

In one embodiment, the processor 12 may record and/or indicate a specific location (e.g., in or near a washroom) suitable for deploying the feedback terminal 70, provided the Wi-Fi circuitry may receive a network signal strength greater than or equal to a preset signal threshold value at such specific location. In one example, the signal threshold value may be set to (minus) −70 decibels (dB). Other examples of the signal threshold value may include −60 dB, −50 dB, −40 dB, and −30 dB. The attendant may take the feedback terminal 70 at different locations proximate to the washroom to check the network signal strength associated with the connected network such as the Wi-Fi™ network at those locations. In one example, the attendant may select a specific position at which the feedback terminal 70 may display the received network signal strength greater than or equal to the signal threshold value. In some examples, the processor 12 may be configured to provide an indication in response to detecting a specific spatial position proximate to the washroom where the network signal strength may be greater than or equal to the signal threshold value during the Wi-Fi check mode. The indication may assist the user to select the corresponding spatial position for deploying the feedback terminal 70. Upon selecting the position for deployment, the attendant may deactivate the Wi-Fi check mode by pressing the same combination C2 of the push-buttons 42 together for the preset duration and return the feedback terminal 70 to the sleep mode. Unlike the traditional solutions relying on a separate device to check for the signal strength, the Wi-Fi check mode facilitates (1) checking the Wi-Fi™ signal strength on the feedback terminal 70, (2) determining a suitable position for physically deploying the feedback terminal 70, e.g., proximate to the washroom, based on the received network signal strength being greater than or equal to the signal threshold value, and (3) reducing system hardware and operational costs.

### Exemplary Engagement

Upon deployment, the portable apparatus 10 such as the feedback terminal 70 may be made available for users (e.g., customers) to provide feedback, e.g., regarding the washroom hygiene and the surrounding area. The feedback terminal 70 may include the push-buttons 42 and a machine-readable indication such as the QR code 72 displayed on the display unit 16. The user may either individually press any of the push-buttons 42 or scan the QR code 72 to provide feedback regarding the perceived ambient conditions in and around the washroom. Whilst the feedback terminal 70 may be operating in the sleep mode, any button press may activate the feedback mode.

In a first exemplary scenario, the user may individually press one or more of the push-buttons 42 to provide the feedback during the feedback mode. For example, the user may press any of the issue buttons 42-1, such as the push-button 42-1a to indicate “Empty Consumables”, the push-button 42-1b to indicate “Full Bin”, the push-button 42-1c to indicate “Dirty Sink”, the push-button 42-1d to indicate “Dirty Toilet”, and the push-button 42-1e to indicate “Dirty Floors”. The user may also press the non-issue push-button 42-2, such as the smiley button, to indicate that the user may be feeling happy or satisfied with the current state of hygiene in an indoor location such as the washroom.

Each time a push-button may be pressed, the processor 12 may activate a light source (e.g., an LED, etc.) coupled to the pressed push-button. The light source may be activated for a preset duration and indicate to the user that an input based on the corresponding button press may have been received. The activation of the light source may also indicate a preset delay introduced by the processor 12 to register a valid input. Upon pressing the same push-button twice prior to the light source being turned-off (i.e., the push-button pressed again before the expiry of the preset delay), the processor 12 may undo or reject the valid input associated with the pressed push-button. In some examples, the processor 12 may also reject or disregard an input that may be received upon pressing a push-button before the expiry of a preset delay associated with a different push-button.

Further, the processor 12 may collate feedback data associated with each of the pressed push-buttons during the feedback mode and store such feedback data in the memory 18 (e.g., volatile memory 20). The feedback data may include (i) data associated with a pressed push-button, (ii) a clock time at which the push-button may be pressed, and (ii) a data type associated with the pressed push-button. For example, when the user may press the push-button 42-1a, the processor 12 may store in the memory 18 (i) the clock time at which the issue button 42-1a may have been pressed, (ii) the corresponding data type, e.g., “Issue”, and (iii) the associated data, e.g., “Full Bin”.

The processor 12 may also (1) associate or tag the feedback data with the unique ID of the feedback terminal 70, thereby indicating the source or origin of such feedback data, (2) update a counter value for each valid input received upon pressing a push-button, (3) cause to display the updated counter value on the display unit 16. For example, if the counter value may be initially displayed as “3” on the display unit 16, the user pressing a push-button, e.g., issue button 42-1a, may cause to update and display the counter value as “4” on the display unit 16. Unlike the traditional solutions relying on a sophisticated mobile app or a web portal for receiving user feedback, the feedback terminal 70 including physical press buttons may provide (1) an intuitive solution with reduced maintenance costs for receiving the user feedback, and (2) a more satisfying tactile feedback and sensory experience to encourage the user to interact with the feedback terminal 70, thereby increasing the likelihood of receiving the user feedback.

The processor 12 may send the tagged feedback data to the server 110 in some examples. During the data upload mode, the processor 12 may wake-up the network circuitry such as the Wi-Fi circuitry from the sleep mode. The processor 12 may initiate the network circuitry only at preset intervals and for preset duration. The processor 12 may connect to the Wi-Fi™ network via the Wi-Fi circuitry, send the tagged feedback data to the server 110, and then put the Wi-Fi circuitry back into sleep mode. Unlike the traditional solutions needing continuous connection to the network 28 for receiving and recording the user feedback, the data upload mode (2) provides for a low-cost solution capable of receiving and collating user feedback locally even without the network 28 connection, and (2) reduces battery consumption by triggering the network circuitry only at preset intervals and/or for preset durations, in a non-continuous manner.

In a second exemplary scenario, the user may scan the machine-readable indication, such as the QR code 72 displayed on the display unit 16 for providing the feedback. For example, the user may scan the displayed QR code 72 using a remote computing device such as the mobile phone 100 for providing the feedback. In one embodiment, the displayed QR code 72 may include a secure hash value, the unique ID of the feedback terminal 70, and a network address (collectively, QR code data). The hash value may provide a security feature to validate the QR code 72 on a remote computing device, such as the server 110, thereby making the QR code secure. The QR code 72 may be implemented as a dynamic, secure QR code 72, where the processor 12 may update the QR code 72 periodically during the data update mode. The processor 12 may run the data update mode at preset intervals and for short preset durations. In the feedback terminal 70, the processor 12 may generate the dynamic QR code based on the hash value and at least one of the unique ID of the feedback terminal 70 and a user key related to a user profile associated with the feedback terminal 70. The processor 12 may update the hash value in the QR code data, e.g., by generating a new hash value, based on a change in an hour of the day in the current clock time of the feedback terminal 70. The processor 12 may use the new hash value to dynamically update the dynamic, secure QR code 72, on an hourly basis. Upon update, the processor 12 may (1) cause to display the generated dynamic, secure QR code 72 on the display unit 16, and (2) invalidate the previously displayed QR code after generation and display of the new QR code, which may include the updated hash value.

The mobile phone 100 may include a controller that may extract and process the QR code data to access a predefined webpage (or website) associated therewith. For example, the controller 102 may use the network address in the QR code data to access the corresponding destination (e.g., webpage, website, host device, etc.). In one embodiment, the network address may provide a reference to a predefined webpage (or a website) featuring the digital replica 120 of the portable apparatus 10 such as the feedback terminal 70. In some examples, the network address may be encoded in the QR code data for use as the network location identifier by the controller 102 to connect the mobile phone 100 with a remote computing device, such as the server 110. In some other examples, the server 110 may host a website (or webpage) featuring the digital replica 120 of the feedback terminal 70.

In one embodiment, the predefined webpage (or website) may feature a digital apparatus including the digital replica 120 of the feedback terminal 70. The digital replica 120 (and in turn, the digital apparatus) may be associated with the unique ID of the feedback terminal 70. The digital replica 120 (or the digital apparatus) may have substantially the same appearance or resemblance to the corresponding physical feedback terminal 70. For example, the digital replica 120 may include digital buttons 122 and a virtual display unit 124. Each of the digital buttons 122 may look and operate similar to the push-buttons 42 of the feedback terminal 70 respectively, where the digital buttons 122-1 may be configured as virtual issue buttons and the digital button 122-2 may be configured as the virtual smiley button, similar to the push-buttons 42 on the corresponding physical feedback terminal 70.

Similar to the physical display unit 16 on the feedback terminal 70, the virtual display unit 124 may also display messages when the corresponding digital buttons 122 may be manipulated. In some examples, the digital buttons 122 alone or in combination with the virtual display unit 124 may operate to provide the digital apparatus on the display screen 106 of the mobile phone 100 via the webpage. In some examples, the webpage may also include a special content 126 unrelated to the digital replica 120 or the feedback terminal 70. The special content 126 may be independent of the unique ID of the feedback terminal 70. The special content 126 may include instructional content, educational content, non-educational content, or promotional content, or any combinations thereof.

The user may click or touch the digital buttons 122 for the controller 102 to register or receive an input (or feedback). Upon registering the input, the controller 102 may capture digital output data including (i) a data type (e.g., “issue” or “non-issue”) associated with the clicked digital button, (ii) a type of issue (e.g., “Empty Consumables”, “Full Bin”, “Satisfied”, etc.) associated with the clicked digital button, and (iii) the clock time at which the corresponding digital button may be clicked. The controller 102 may send the captured digital output data to the server 110 via the network 28. The controller 102 may also provide an indication, such as displaying a message on the virtual display unit 124 of the digital replica 120, based on the digital buttons 122 being clicked or touched. In one embodiment, the controller 102 may tag the digital output data with the unique ID of the portable apparatus 10, such as the feedback terminal 70. The step of tagging may indicate to the server 110 that the associated digital output data may have been received from the portable apparatus 10 such as the feedback terminal 70, thereby associating the digitally-generated output data with the physical portable apparatus 10 such as the feedback terminal 70. In some examples, the step of tagging may be performed by the server 110.

Unlike the traditional solutions relying on a location-agnostic and complex mobile app or web portal for receiving user feedback, the digital replica 120 of the feedback terminal 70 (and the special content 126) provides a simple, intuitive, and familiar interface that (1) eliminates the need for any training or study for the user to provide feedback, (2) allows the user to provide feedback remotely, and (3) provides an option to incentivize the user to provide feedback, e.g., through the special content 126, and (4) enables automated location-based feedback mapping by associating the feedback data (and the digital output data) with the unique ID of the physical feedback terminal 70 deployed at a known location.

### Exemplary Management

In one embodiment, the server 110 may send notifications to network devices linked to the user profile associated with the feedback terminal 70 in response to receiving the feedback data (or the digital output data). For example, the server 110 may send out notifications to mobile phones linked to one or more user profiles associated with the feedback terminal 70 upon receiving the feedback data. In some examples, the functionality of sending out notifications may be implemented on the feedback terminal 70, where the processor 12 may send out notifications to network devices linked to the user profile during the data upload mode. In response to the notifications, the attendant may arrive at the location of the feedback terminal 70 to fix the issues indicated in the feedback data.

In order to record the local activity being performed locally proximate to an area, such as the washroom, where the feedback terminal 70 may be deployed, the attendant may activate the validation mode for initiating the cleaning mode on the feedback terminal 70. For example, the attendant may press-and-hold a set combination of push-buttons (namely, combination C3) on the feedback terminal 70. When the set combination C3 of push-buttons may be pressed together for a preset duration, the processor 12 may activate the validation mode on the feedback terminal 70.

The validation mode may be configured to timeout and stop after a preset duration by the processor 12 and return the feedback terminal 70 to the sleep mode. In the validation mode, the processor 12 may provide an indication to confirm the initiation of the validation mode and request the user to enter a passcode of a preset length. The processor 12 may keep the validation mode active until either the preset duration associated therewith expires or the correct passcode of preset length may be received.

When the passcode of the preset length may be received, the processor 12 may turn on the network circuitry, such as the Wi-Fi circuitry, and connect to the predefined Wi-Fi™ network based on the network configuration file including the login credentials stored in the memory 18. The processor 12 may then send the user-entered passcode to the server 110 over the network 28 and await a response. In one example, the processor 12 may receive the passcode verification file including the correct passcode in the response received from the server 110. The processor 12 may compare and verify the user-entered passcode with the passcode in the passcode verification file. Alternatively, the server response may include a data bit value indicating whether or not the user-entered passcode may be correct. For instance, the passcode verification file (or the server response signal) may include a data bit having a set value, where the set value being “1” may indicate that the user passcode may be correct and the set value being “0” may indicate that the user passcode may be incorrect. If no server response (or no passcode verification file) may be received prior to the expiry of the preset response wait time duration, the processor 12 may end the validation mode and switch the feedback terminal 70 back to the sleep mode. If, however, the user-entered passcode may be verified to be correct, the processor 12 may (i) turn-off the Wi-Fi circuitry, (ii) end the validation mode, and (iii) switch on the cleaning mode on the feedback terminal 70.

In the cleaning mode, the processor 12 may provide an indication regarding the initiation of the cleaning mode. While the attendant may perform the local activity to address the issues raised in the feedback data by the user, the processor 12 may record the cleaning data including a start clock time and a duration for which the cleaning mode may be activated. The cleaning mode may indicate a local activity (e.g., cleaning activity) being performed in an area, such as a washroom, where the feedback terminal 70 may be deployed.

Upon completing the local activity, the attendant may deactivate the cleaning mode by pressing the same combination C3 of the push-buttons 42 together used to activate the validation mode and make the feedback terminal 70 return to the sleep mode. In some examples, the cleaning mode may be configured to stop automatically after a preset duration by the processor 12. Such automated termination of the cleaning mode may (i) prevent battery wastage and (ii) make the feedback terminal 70 available for use by the user to provide feedback, when the attendant may have inadvertently forgotten to deactivate the cleaning mode using the combination C3 of the push-buttons 42.

The processor 12 may also record the end clock time in the cleaning data. In some examples, the end clock time may represent a time at which the cleaning mode may be deactivated. Based on the end clock time, the processor 12 may determine, update, and cause to display the time elapsed since the last deactivation of the cleaning mode during the data update mode. The processor 12 may run the data update mode at preset intervals and for short preset durations. Unlike the traditional solutions relying on multi-device system of pre-linked devices to activate or deactivate the cleaning mode, the combination of validation mode and the cleaning mode operating on an auto-deactivation feature on the feedback terminal 70 facilitates (1) reducing battery usage, (2) avoiding error states related to loss of pre-linked devices, and (2) decreasing operational and maintenance costs. Moreover, the feedback terminal 70 operates with minimal and simple hardware and related software, has minimal to no set-up time, and runs free of any computational and memory overheads while facilitating responsive feedback management.

While the foregoing written description of the invention would enable one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiments, methods, and examples, disclosed in the present application.

I/We claim:

1. A system, comprising:
a portable apparatus including one or more physical press buttons, wherein the portable apparatus is configured to perform a function in response to the one or more physical press buttons being manipulated; and
a display device operating in communication with the portable apparatus, wherein the display device is configured to display a machine-readable code including a reference to a webpage featuring a digital replica of the portable apparatus.

2. The system of claim 1, wherein the machine-readable code includes at least one of a quick response (QR) code, a data matrix code, an Aztec code, PDF417 codes, Snapcode™, and an Augmented Reality (AR) tag, wherein the machine-readable code is updated periodically.

3. The system of claim 1, wherein the portable apparatus is further configured to:
access a unique identifier and a current clock time associated with the portable apparatus, the current clock time including an hour of the day, a minute of the day, and a second of the day, wherein the current clock time is in a local time standard;
access a user key associated with the unique identifier, wherein the user key relates to a user profile associated with the portable apparatus;
convert the current clock time into a standardized time including an hour of the day in a preset time standard;
generate a hash value by using the hour of the day in the preset time standard and at least one of the unique identifier and the user key; and
generate the machine-readable code for display based on the hash value.

4. The system of claim 3, wherein the portable apparatus is further configured to:
update the hash value based on a change in the hour of the day in the standardized time, wherein the updated hash value is generated by using the changed hour of the day in the preset time standard and at least one of the unique identifier and the user key;
generate a new machine-readable code based on the updated hash value; and
invalidate the machine-readable code upon generation of the new machine-readable code.

5. The system of claim 4, wherein the portable apparatus is further configured to replace the machine-readable code with the new machine-readable code on the display device.

6. The system of claim 3, wherein the portable apparatus is further configured to skip the step of converting based on the local time standard being same as the preset time standard.

7. The system of claim 1, further comprising:
a user interface displaying the digital replica of the portable apparatus, the digital replica including one or more digital buttons, wherein the digital replica is associated with a unique identifier of the portable apparatus; and
a controller operating in communication with the user interface, wherein the controller is configured to:
perform the function independent of the portable apparatus, the function being performed in response to the one or more digital buttons being manipulated, wherein the controller provides an output based on the function being performed; and
associate the output with the unique identifier of the portable apparatus.

8. The system of claim 1, wherein the function includes at least one of (i) generating a pulsed signal, (ii) initiating a trigger event relating to an operation, (iii) initiating or inhibiting a component, (iv) performing the operation, and (v) providing an indication related to the operation.

9. The system of claim 1, wherein the reference includes a network address relating to a remote device.

10. The system of claim 1, wherein the webpage includes a content unrelated to the digital replica, wherein the content includes at least one of an instructional content, an educational content, and a non-educational content including a promotional content.

11. The system of claim 1, wherein the portable apparatus includes a handheld device.

12. A system, comprising:
a user interface displaying a digital replica of a remote apparatus, the digital replica including one or more digital buttons, wherein the digital replica is associated with a unique identifier of the remote apparatus configured to perform a function; and
a controller operating in communication with the user interface, wherein the controller is configured to:
perform the function independent of the remote apparatus, the function being performed in response to the one or more digital buttons being manipulated, wherein the controller provides an output based on the function being performed; and
associate the output with the unique identifier of the remote apparatus.

13. The system of claim 12, wherein the remote apparatus includes one or more physical press buttons, wherein the remote apparatus performs the function in response to the one or more physical press buttons being manipulated.

14. The system of claim 12, wherein the function includes at least one of (i) generating a pulsed signal, (ii) initiating a trigger event relating to an operation, (iii) initiating or inhibiting a component, (iv) performing the operation, and (v) providing an indication related to the operation.

15. The system of claim 12, wherein the digital replica includes a virtual display screen configured to provide an indication in response to the function being performed.

16. The system of claim 12, wherein the remote apparatus includes a machine-readable code including a reference to a webpage featuring the digital replica of the remote apparatus.

17. The system of claim 16, wherein the machine-readable code includes a security feature configured to be updated periodically, wherein the security feature is updated by the remote apparatus based on a change in an hour of the day in a current clock time associated with the remote apparatus.

18. The system of claim 17, wherein the security feature includes a hash value generated based on the hour of the day in a preset time standard and at least one of a user key and the unique identifier, wherein the user key relates to a user profile associated with the remote apparatus.

19. The system of claim 16, wherein the webpage includes a content unrelated to the digital replica, wherein the content includes at least one of an instructional content, an educational content, and a non-educational content including a promotional content.

20. The system of claim 12, wherein the remote apparatus includes a handheld device.
